(19) United States
(12) Patent Application Publication
(10) Pub. No.: US 2026/0338518 A1
(43) Pub. Date: Oct. 29, 2026

(54) ADJUSTABLE CLIP SYSTEM FOR HOLSTERS AND SHEATHS

(71) Applicant: Richard Jason Price, Fort Myers, FL (US)

(72) Inventor: Richard Jason Price, Fort Myers, FL (US)

(21) Appl. No.: 19/253,678

(22) Filed: Jun. 27, 2025

Related U.S. Application Data
(63) Continuation-in-part of application No. 18/171,492, filed on Feb. 20, 2023, now Pat. No. 12,359,891.
Application No. 18/171,492 is a continuation-in-part of application No. 17/856,319, filed on Jul. 1, 2022, now Pat. No. 11,885,590.

(51) Int. Cl. F41C 33/04; F41C 33/02

(52) U.S. Cl. CPC F41C 33/041; F41C 33/0209

(57) ABSTRACT

A position adjustable holster or sheath includes housing first and second side, a compartment formed by the housing first side and the housing second side, and a channel member disposed on the housing first side, the channel member having a slot extending along a second length of the channel member. The position adjustable holster or sheath includes an attachment bracket slidably attached to the slot to allow the attachment bracket to slide along the slot in relation to the housing first side. The position adjustable holster or sheath includes an at least one fastener extending through an at least one opening in the attachment bracket and through the slot wherein the attachment bracket fastener secures the at least one attachment bracket slidably to the channel member. The position adjustable holster or sheath may include an accessory channel extending from a side of the position adjustable holster or sheath.

### CROSS-REFERENCE TO RELATED APPLICATIONS

This application is a Continuation-In-Part Utility Patent application claiming priority to U.S. patent application Ser. No. 18/171,492, filed on Feb. 20, 2023, which claims priority to U.S. patent application Serial No. 17/856,319, filed on Jul. 1, 2022, both of which are incorporated by reference herein in their entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks are used in the disclosure of the invention, and the applicants, make no claim to any trademarks referenced.

### BACKGROUND OF THE INVENTION

### 1) Field of the Invention

The present invention relates to the field of holsters and sheaths used for carrying tools, firearms, knives, handheld weapons, Taser® and defense tools, and more specifically, the present invention relates to an adjustable clip system that allows the height and position of a holster or holster rig to be independently adjusted in relation to a wearer's waistband, belt, pocket, or off-body carry such as with a bag or mounting device.

### 2) Description of Related Art

Currently the state of the art includes various holsters and sheaths designed to carry tools and weapons such as a firearm, knife, handheld light, defense tool, and Taser® non-lethal handheld weapon.

A holster is a device that is most commonly used to hold or restrict the undesired movement of a firearm or handheld weapon in a location where the handheld weapon may be accessible for use. As used in the art, holsters are often attached to a belt or waistband and generally designed to offer protection to the handheld weapon, secure its retention, and provide ready access to it.

The need for ready access to a firearm or handheld weapon is often at odds with keeping the firearm or handheld weapon concealed while also maintaining the comfort of the wearer. For example, many individuals use inside the waistband (IWB) holsters, which clip or mount to a belt or pants. A variant design of the IWB is an appendix inside the waistband (AIWB) holster, intended to allow a holster to be worn inside the front of the pants as opposed to the side or rear of the waistband. Appendix rigs are a variant design of AIWB holsters and have an attached magazine holder and/or other attached accessory. A second-conjoined holster such as that for a magazine is commonly referred to as a “sidecar holster”. Many conventional appendix and other styles of holsters are modular in design, thereby allowing a rig to be customized by the intended user.

Current licensing laws adopted by many states require an individual carrying a handheld weapon to maintain concealment of the handheld weapon. Because of the nature of existing holsters, this can be cumbersome. Concealed carry is a common practice for investigators, law enforcement, security, and constitutionally law-abiding citizens. Such tools can be worn/carried on-or off-person. On-person carry is the preferred method for the purpose of access, accountability, and retention. The most popular styles for concealed carry include those of IWB. Among those styles, one of the most common and increasingly popular is AIWB.

In general, carrying a tool in concealment maintains a level of discomfort in regard to wearing the tool and its limitations on performing day-to-day tasks. This is due to a combination of factors such as the weight, size, shape, and orientation of the tool being carried in concealment and its physical impediment on the user's range of motion and comfort. This is particularly the case when such tools are worn AIWB. Having a tool in your waistband acts as an obstacle to effective hip flexion and/or bending. It is not to say that the wearer of a holster is not physically capable of achieving a normal range of motion associated with day-to-day tasks while in the use of ordinary holsters. However, when worn properly, the present invention acts to increase the comfort of the use of such holsters or sheaths when performing activities.

Many conventional holsters, such as AIWB holsters, share the same drawbacks. For example, it is necessary to adjust and/or reposition holsters, such as appendix holsters or appendix rigs, side-carried holsters, pocket holsters, and so forth prior to sitting down. This is necessary to maintain safe and comfortable access to the firearm and/or other items being carried.

If the holster or rig is not pulled upward and/or repositioned prior to sitting, then the holster and firearm are forced into an angled position on the wearer's body, thereby limiting ready access to the firearm and/or other items being carried.

For example, to avoid this with an appendix carry holster, a wearer must pull or adjust the wearer's waistband and belt simultaneously with the attached holster and firearm or handheld weapon upward over the wearer's navel, so the firearm is positioned superiorly on the abdomen while sitting, bending, or squatting. This can be a challenging and/or uncomfortable task to accomplish.

Therefore, a need exists for an adjustable clip system that allows a height and position of a holster and/or holster rig to be independently adjusted in relation to a wearer's waistband, belt, pocket, or other attachment point.

### BRIEF SUMMARY OF THE INVENTION

The instant invention in one form is directed to an adjustable clip system that allows a height of a sheath, holster, or holster rig to be independently adjusted in relation to a wearer's waistband, belt, pocket, or other attachment point.

The present invention achieves the above and other objects by providing an adjustable clip system primarily for use with holsters or holster rigs wherein the adjustable clip system provides a channeled member which is preferably a channeled plate that attaches to a holster and/or holster rig in respective fixed positions. A belt clip or attachment bracket is slidably attached to the channeled member using at least one spacer, such as a spring, a rubber non-slip washer, or equivalent, and at least one fastener such as stud, rivet, threaded fastener, or ratcheting fastener that engages a slotted channel. The at least one spacer remains in an interfering state, thereby impeding the movement of the channeled plate and respective clip together.

Non-slip, compressible or textured surfaces, such as interlocking ridges or locking notches, may be located on a surface of each channeled member and/or a surface of the clip to allow the surfaces to interlock with each other when pressed together by the at least one spacer. Preferably, the spacer is a spring, compressible spacer, or non-compressible spacer that provides enough force wherein a non-slip or textured surface is not necessary.

The device may be adjusted by applying sufficient force by means of pressing or lifting the channeled member and/or holster/rig attached to the channeled member in relation to the clip to overcome the force applied by the interfering spacer(s) and/or interfering textures. Force can be applied directly to the clips to aid in minimizing the engagement of the spacer(s) or interfering textures, resulting in disengagement of the channeled member. Each individual channeled member enables the mounted side to translate along the length of the respective channel. This allows the holster and/or rig to be carried and for a wearer to make intermediate adjustments for comfort. Ultimately, the wearer is enabled to adjust the position of the holster and/or holster rig while sitting or standing without being required to adjust the position of the wearer's pants, reposition clothing, or loosen and re-tighten clip mounting fasteners.

One aspect of the present invention is directed to an adjustable clip system securable to a sheath, holster, or holster rig for allowing a height and/or position of the holster to be adjusted in relation to an attachment point on a wearer. The adjustable clip system includes a channeled plate having a first slot and a second slot adjacent to the first slot wherein the channeled plate is attachable to the holster. The adjustable clip system includes at least one attachment fastener extending through the first slot and secured to an opening in the holster for securing the channeled plate to the holster. The adjustable clip system includes at least one attachment bracket, which is preferably a U-shaped clip, being slidably attached to the at least one second slot to allow the U-shaped clip to slide in relation to the at least one second slot, the U-shaped clip or attachment bracket remaining stationary with respect to the wearer. The holster may be a holster rig. The holster may be a sheath. The channeled plate may be adjustably attachable to the holster. The channeled plate may be a channeled member. The channeled plate may include at least one attachment fastener for attaching the channeled member to the holster. The U-shaped clip may be an attachment bracket. The adjustable clip system may include the at least one fastener for slidably retaining the at least one spacer and the U-shaped clip to the second slot. The at least one spacer may be a spring, compressible spacer, or non-compressible spacer. The adjustable clip may include a textured, compressible, interlocking, or non-slip surface on a surface of the holster or clip to provide engagement. The attachment fastener may be a stud, rivet, threaded rivet and nut, ratcheting fastener, or threaded fastener. An attachment fastener as described in any embodiment of the clip system described herein, is meant to describe a fastener which is used to secure components of the invention together without further adjustments required to the fastener after the initial set up of the clip system.

Another aspect of the present invention is directed to an adjustable clip system securable to a sheath, holster, or holster rig for allowing a height and/or position to be adjusted in relation to an attachment point on a wearer. The adjustable clip system includes a channeled plate having a first slot and a second slot adjacent to the first slot wherein the channeled plate is attachable to the holster. The adjustable clip system includes at least one attachment fastener extending through the first slot and secured to an opening in the holster for securing the channeled plate to the holster. The adjustable clip system includes at least one U-shaped clip or attachment bracket being slidably attached to the at least one second slot to allow the U-shaped clip to slide in relation to the at least one second slot, the U-shaped clip remaining stationary with respect to the wearer. The adjustable clip system includes at least one fastener retaining at least one spacer for slidably attaching the U-shaped clip to the second slot. The adjustable clip system includes an adjustable torsion claw. A fastener and spacer are used to slidably retain an adjustable torsion claw bracket to an adjustable torsion claw upper mounting base of the adjustable torsion claw. The adjustable torsion claw bracket attaches an adjustable torsion claw cap to the adjustable torsion claw upper mounting base through a torsion claw cap extension thereof, the torsion claw cap locking into the adjustable torsion claw bracket groove of the adjustable torsion claw upper mounting base. An attachment fastener is used to attach an adjustable torsion claw lower mounting base of the adjustable torsion claw to the holster or holster rig. The adjustable torsion claw upper mounting base and adjustable torsion claw lower mounting base of the adjustable torsion claw are attached by a fastener through an opening in the adjustable torsion claw upper mounting base and adjustable torsion claw lower mounting base. The U-shaped clip may be an attachment bracket. The adjustable clip system may include a textured, compressible, interlocking, or non-slip surface between the clip and channeled plate to increase engagement. The at least one spacer may be a spring, compressible spacer, or non-compressible spacer. The attachment fastener may be a stud, rivet, threaded rivet and nut, threaded fastener, or ratcheting fastener. The adjustable torsion claw attachment fastener may be a stud, rivet, ratcheting fastener, or threaded fastener. The adjustable clip and/or adjustable torsion claw system may include a textured, compressible, interlocking, or non-slip surface on a surface of the holster, clip, adjustable torsion claw bracket, and/or adjustable torsion claw upper mounting base to provide engagement.

Another aspect of the present invention is directed to a method for installing an adjustable clip system securable to a holster for allowing a position and/or height of the holster to be adjusted in relation to an attachment point on a wearer. The method includes providing a holster and ensuring the holster has a slot disposed on a portion of the holster. The method includes providing a U-shaped clip or attachment bracket, the U-shaped clip having a mounting portion with a clip mounting opening. The method includes providing a fastener having a stud portion with a first stud end and a second stud end opposite the first stud end. The fastener has a head portion removably attachable to the stud first end and a base portion attached to the stud second end. The method includes providing a spacer, ensuring the fastener head has been removed from the fastener stud and extending the first end of the fastener stud through the spacer until the fastener base portion contacts the spacer. The method includes extending the first end of the fastener stud through the holster slot until the spacer contacts the holster, extending the first end of the fastener stud through the clip mounting opening and engaging the fastener head to the first stud end. The method includes tightening the fastener head onto the stud first end, securing the U-shaped clip to the wearer's desired point of attachment and adjusting the holster along the length of the slot in the holster. The fastener head can be adjusted to increase or decrease the engagement of the spacer and/or clip against the slotted channel to add or remove resistance for sliding of the spacer, stud, and/or clip along the slotted channel. The holster may be a holster rig. The U-shaped clips may be an attachment bracket. The holster may be a sheath. The method is effectively achieved through reversing the placement of the stud first end, whereas the fastener head is removed from the fastener stud first end. The fastener stud first end is extended through the clip mounting opening of the clip until the fastener base portion engages the clip mounting base. The fastener stud first end is extended through the slot in the holster. The fastener stud first end is extended through the spacer. The fastener head can be adjusted to increase or decrease the engagement of the spacer and/or clip against the slotted channel to add or remove resistance for sliding of the spacer, stud, and/or clip along the slotted channel. The user may then don the holster by attaching the U-shaped clips to the user's desired attachment point and adjust the holster along the length of the slot to the functional position of comfort. The U-shaped clip may be an attachment bracket. The at least one spacer may be a spring, compressible spacer, or non-compressible spacer. The attachment fastener may be a stud, rivet, threaded rivet and nut, threaded fastener, or ratcheting fastener. The adjustable clip system of the above methods may include a textured, compressible, interlocking, or non-slip surface on a surface of the holster or clip to increase engagement.

The use of the term “slot” may be used interchangeably with the term “opening” or “hole” when specifically applied to the channeled member. The use of the slot as the opening in the channeled member is the preferred embodiment. Alternative forms of the opening may exist to facilitate various patterns for attachment to holsters, holster rigs, and sheaths maintaining different attachment footprints.

Another aspect of the present invention is directed to a position adjustable holster or sheath including a housing first side and a housing second side. The position adjustable holster or sheath includes a compartment for placement of a tool, the compartment formed by the housing first side and the housing second side. The position adjustable holster or sheath includes a channel member disposed on a first length of the housing first side, the channel member having a slot extending along a first length of the channel member. The position adjustable holster or sheath includes at least one attachment bracket being slidably attached to the slot to allow the attachment bracket to slide along the length of the slot in relation to the housing first side, the attachment bracket remaining stationary with respect to the wearer. The position adjustable holster or sheath includes at least one spacer for providing engagement between the channel member and attachment bracket. The position adjustable holster or sheath includes at least one attachment bracket fastener extending through an opening in the attachment bracket, the spacer, and through the slot wherein the attachment bracket fastener secures the at least one attachment bracket slidably to the channel member. The position adjustable holster or sheath may include an accessory channel extending from a side of the position adjustable holster or sheath, the accessory channel for adjustably securing an accessory to the position adjustable holster or sheath. The channel member may include a textured, compressible, interlocking, or non-slip surface. The channel member may be a raised portion of the housing first side. The at least one attachment bracket fastener may be a stud for retaining a spacer for slidably attaching the attachment bracket to the slot. The at least one stud may be a rivet or a ratcheting fastener having a first flange on a first end integrated with a threaded cylinder and a second flange disposed on a second end opposite the first end, the second flange engageable with the threaded cylinder. The at least one spacer may be a spring, compressible spacer, or non-compressible spacer. The attachment bracket may include a bracket opening for accessing the at least one attachment bracket fastener. The position adjustable holster may include a textured, compressible, interlocking, or non-slip surface on a surface of the holster, channel member, or attachment bracket to increase engagement.

Another aspect of the present invention is directed to an alternative adjustable torsion claw securable to a sheath or holster for allowing a position of the torsion claw to be adjusted in relation to the sheath or holster. The adjustable torsion claw includes a torsion claw base having a torsion claw base slot disposed in a torsion claw base groove. A torsion claw face having a textured surface, may be disposed in a torsion claw groove of the torsion claw base and is attachable by a torsion claw face extension. The adjustable torsion claw includes a torsion claw mounting base for slidably mounting the torsion claw base to the sheath or holster, the torsion claw mounting base including at least one fastener opening. The adjustable torsion claw includes at least one fastener extending through an at least one fastener opening for slidably fastening the torsion claw base to the torsion claw mounting base, the at least one fastener including a first flange having a threaded cylinder protruding therefrom and a second flange engageable with the threaded cylinder, the at least one torsion claw fastener extending through the slot in the torsion claw base. The adjustable torsion claw includes at least one spacer disposed between the first flange of the fastener and the torsion claw base slot to slidably attach the torsion claw base to the torsion claw mounting base. The adjustable torsion claw may include a torsion claw mounting base fastener for securing the torsion claw mounting base to the sheath or holster. The torsion claw base or torsion claw mounting base may include a textured, compressible, interlocking, or non-slip surface. The at least one spacer may be a spring, compressible spacer, or non-compressible spacer. The at least one mounting base fastener may be a stud, rivet, threaded rivet and nut, threaded fastener, or ratcheting fastener.

Another aspect of the present invention is directed to an adjustable clip system for slidably attaching a holster or sheath to a wearer. The adjustable clip system includes a bracket plate having a bracket slot, the bracket plate attachable to the holster or sheath. The adjustable clip system includes an attachment bracket slidably attached to the bracket plate by an at least one attachment bracket fastener. The adjustable clip system includes an at least one bracket plate fastener for attaching the bracket plate to the holster or sheath. The bracket plate includes an at least one bracket plate opening for extending the at least one bracket plate fastener therethrough, for securing the bracket plate to the holster or sheath. The attachment bracket may be attachable to the wearer and the bracket plate allows the holster to be slidably positioned with respect to the wearer. The at least one attachment bracket fastener may be a stud for retaining a spacer for slidably attaching the attachment bracket to the bracket slot. The at least one stud may be a rivet, a threaded fastener, or a ratcheting fastener having a first flange on a first end integrated with a threaded cylinder and a second flange disposed on a second end opposite the first end, the second flange engageable with the threaded cylinder. The at least one bracket plate fastener may include a first flange on a first end integrated with a threaded cylinder and a second flange disposed on a second end opposite the first end, the second flange engageable with the threaded cylinder. The adjustable clip system may include a textured, compressible, interlocking, or non-slip surface on a surface of the clip/attachment bracket and/or bracket plate. The attachment bracket may include a bracket opening for accessing the at least one attachment bracket fastener. The adjustable clip system may include an at least one spacer and the at least one spacer may be a spring, compressible spacer, or non-compressible spacer.

The above and other objects, features, and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a front view of an appendix carry holster rig having an adjustable clip system of the present invention mounted thereto wherein the holster rig is in a lowered position;

FIG. 2 is a front view of the appendix carry holster rig having the adjustable clip system of the present invention mounted thereto wherein the holster rig is in a raised position;

FIG. 3 is a front view of the appendix carry holster rig having the adjustable clip system of the present invention mounted thereto wherein the holster rig is in a lowered position on a wearer's waist and abdomen;

FIG. 4 is a front view of the appendix carry holster rig having the adjustable clip system of the present invention mounted thereto wherein the holster rig is in a raised position on a wearer's waist and abdomen;

FIG. 5A is a side view of the attachment bracket, channeled plate, fastener, holster fastener, and spacer of the adjustable clip system of the present invention;

FIG. 5B is a side view of the attachment bracket, channeled plate, spring, fastener, holster fastener, and spacer of the adjustable clip system of the present invention;

FIG. 6A is a perspective view of the attachment bracket, channeled plate, fastener, holster fastener, and spacer of the adjustable clip system shown in FIG. 5A;

FIG. 6B is a perspective view of the attachment bracket, channeled plate, spring, fastener, holster fastener, and spacer of the adjustable clip system shown in FIG. 5B;

FIG. 7 is a bottom perspective view of the attachment bracket, channeled plate, fastener, holster fastener, and spacer of the adjustable clip system shown in FIG. 5A and FIG. 5B;

FIG. 8 is a front view of the appendix carry holster rig having an adjustable clip system shown in FIG. 1 and an adjustable torsion claw;

FIG. 9 there is shown a perspective front view of a second embodiment of the adjustable clip system and an alternative embodiment of the adjustable torsion claw, the adjustable position holster having an integrated attachment channel or a holster slot wherein the slot is milled, attached, or integrated in the sheath, holster, or holster rig for an attachment bracket to slidably attach;

FIG. 10 there is shown a first view of the adjustable position holster and the alternative embodiment of the adjustable torsion claw shown in FIG. 9;

FIG. 11 there is shown a second view of the adjustable position holster shown in FIG. 9 having an electronic module;

FIG. 12A there is shown a sectional lateral view of the adjustable position holster shown in FIG. 9 showing a first attachment bracket installed in the integrated holster channel.

FIG. 12B is shown a side view of the holster shown in FIG. 9 showing the first adjustable attachment bracket installed in the integrated holster channel;

FIG. 13 is shown a bottom view of the adjustable position holster and the alternative embodiment of the adjustable torsion claw shown in FIG. 9 showing the first attachment bracket and a second attachment bracket installed in their respective channels;

FIG. 14 is shown a top view of the adjustable position holster and the alternative embodiment of the adjustable torsion claw shown in FIG. 9 showing the attachment brackets installed in their respective channels;

FIG. 15 is a perspective view of an alternative embodiment of the adjustable clip system having a channel bracket;

FIG. 16 is a lateral view of the channel bracket shown in FIG. 15;

FIG. 17 is a perspective view of a second alternative embodiment of the adjustable clip system having a surface mount channel bracket;

FIG. 18 is a back view of the surface mount channel bracket shown in FIG. 17;

FIG. 19 is a first exploded perspective view of the adjustable torsion claw shown in FIG. 8;

FIG. 20 is a second exploded perspective view of the adjustable torsion claw shown in FIG. 8;

FIG. 21A shows a threaded fastener having a first flange portion engageable with a second flange portion;

FIG. 21B shows the internal core portion of the threaded fastener shown in FIG. 21A;

FIG. 22 shows a permanent rivet according to the present invention;

FIG. 23 shows a spacer according to the present invention;

FIG. 24 shows an inside view of one side of the position adjustable holster or sheath according to the present invention;

FIG. 25 shows an outside view of the one side of the position adjustable holster or sheath shown in FIG. 24;

FIG. 26 shows an exploded outside perspective view of the one side of the position adjustable holster or sheath shown in FIG. 24 with the attachment bracket and fastener;

FIG. 27 shows an exploded inside perspective view of one side of the position adjustable holster or sheath shown in FIG. 24 with the attachment bracket and fastener;

FIG. 28 is a first perspective view of the alternative embodiment of the adjustable torsion claw shown in FIG. 9;

FIG. 29 is a second perspective view of the alternative embodiment of the adjustable torsion claw shown in FIG. 28;

FIG. 30 is a first elevational view of the alternative embodiment of the adjustable torsion claw shown in FIG. 28;

FIG. 31 is a second elevational view of the alternative embodiment of the adjustable torsion claw shown in FIG. 28;

FIG. 32 is an exploded perspective view of the alternative embodiment of the adjustable torsion claw shown in FIG. 28;

FIG. 33 is a perspective view of the adjustable clip system according to the present invention;

FIG. 34 is an exploded perspective view of the adjustable clip system shown in FIG. 33;

FIG. 35 is a first elevational view of the adjustable clip system shown in FIG. 33;

FIG. 36 is a second elevational view of the adjustable clip system shown in FIG. 33;

FIG. 37 is a side elevational view of the adjustable clip system shown in FIG. 33; and

FIG. 38 is an exploded side elevational view of the adjustable clip system shown in FIG. 33.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B and C.” An exception to this definition will occur only when a combination of elements, functions, steps, or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms firearms, knives, handheld weapons, defense tools, and a Taser® non-lethal handheld weapon are used interchangeably to mean a handheld weapon used with a holster of the instant invention.

The term holster as used in the specification is intended to describe either a holder for a tool or weapon, or a sheath for a tool or weapon that is worn by a user.

Prior to a discussion of the preferred embodiment of the invention, it should be understood that the features and advantages of the invention are illustrated in terms of a holster which is enabled to be adjusted while being worn by a user thereby eliminating the handheld device and holster from being an obstacle to effective hip flexion and/or forward bending, and/or provides means of achieving individualized positioning when carried.

The instant invention provides for a channel that spans the full-length of adjustment that is associated with a dynamically or slidably adjustable clip system. The instant invention further envisions integrating into a holster a device using one or more permanent channels as opposed to a bracket.

The instant invention may be used for investigators, law enforcement, security, and law-abiding citizens; and provides a means for moving an attached holster or sheath carried in concealment along the axis of a slotted channel without having to remove the object, use a tool to make adjustments, and/or adjust any permanent means of attachment to achieve such adjustment. The term permanent in this document is intended to describe attachment without requiring continued adjustment to a fastener.

The instant invention provides the user with a comfortable holster by replacing standard attachment brackets (i.e., belt clips) commonly found on a tool holster or sheath, which may be attached to a carriable bag, case, pocket, belt (most common), or otherwise point of attachment with the clip-on-channel system of the instant invention. Concisely, the attachment bracket is attached to a channel by one or more adjustable fasteners with one or more spacers. The attachment bracket, attached by the fasteners, is able to translate along a channel, and translate the length of the channel. The spacers that are attached to the fasteners are positioned adjacent the channel, creating drag or friction against the surrounding surface of the channel. If the fastener is a rivet, the spacer is positioned between a rivet head and the channel. The spacer may also be positioned between a rivet cap and the channel. The resistance caused by the contact of the spacers fixes the attachment bracket in place until otherwise acted on with sufficient force to once again move the attachment bracket along the channel.

Currently, there are no similar products that work by adjusting a concealed firearm, knife, or otherwise on a user while the item remains attached. This is important for the wearer because the statues for concealed carry often stipulate that the wearer must keep the weapon concealed at all times. The instant invention can allow the wearer to keep the weapon concealed both when standing and seated. Similar products require the user to remove the holster, unscrew the fasteners, move the clip, and once again tighten the fasteners to fix the clip in a single orientation. Other products allow for outside the waistband holsters to be vertically adjusted and use a much more complex mechanism that permanently locks a firearm holster in a single position until an actuator is actively engaged by the user. Outside the waistband holsters (i.e., holsters typically used for competition or duty holsters) do not allow for free-dynamic adjustment or concealed options.

The instant invention is a device which includes an attachment bracket or clip that is attached to a slotted-channel, integrated into a holster or sheath, allowing the clip to maneuver from one end to the other of the channel without requiring permanent fixation in a single position; or as a clip attached to a slotted-channel that is part of a bracket, in which the bracket is attached to a holster or sheath, that allows the clip to maneuver from one end to the other of the channeled bracket without requiring permanent fixation in a single position along the length of the channel.

The instant invention is used by being manipulated while attached to an attachment point. The holster is attached by one or more attachment brackets or clips. To position the holster from a fully tucked position in the user's waistband, the user is able to grasp a side of the holster and use directional pressure on the holster while the clips remain attached to an attachment point. To return the device to its near prior position, the process may be reversed by applying countering pressure to a side of the holster while the clips remain attached to an attachment point.

Furthermore, the instant invention solves the problem of reducing the limitations on range of motion and associated activities complicated by the use and application of holsters and sheaths. The adjustable clip system permits the user to make dynamic adjustments to the position of a tool, holster, or sheath while the tool, holster, or sheath remains securely attached to its attachment point on the user or user's accessory, while maintaining the integrity of concealment.

The adjustable clip system furthermore provides the ability for the user to achieve greater comfort when bending laterally or forwardly. A common complaint among users is that the holster or sheath for the handheld weapon is uncomfortable and makes it difficult to wear. The instant invention solves the problem by making the holster, sheath, handheld weapon, or tool fully adjustable while being worn without having to remove the holster, sheath, handheld weapon, or tool, and/or loosen the fasteners for readjustment and resecuring of the clip to the holster.

The first embodiment of the instant invention is an attachment bracket or clip that is attached to a bracket and an adjustable torsion claw. The bracket is attachable to a holster or sheath. The bracket serves a dual purpose; 1) as a permanent point of attachment to the holster or sheath, and 2) as a channel for the clip to translate or slide from one end to the other end of the bracket. The adjustable torsion claw serves a dual purpose; 1) as a permanent point of attachment to the holster or sheath, and 2) as a means to torque the holster or sheath into a wearer's waistline while accommodating for changes in a height and/or position of the holster. The second embodiment integrates a holster or sheath and a bracket into one, by simply creating a channel in the holster, and utilizing spacers, fasteners, and an attachment bracket to translate from one end to the other of the channel while remaining attached to the user.

The instant invention comprises the following components:
a. a holster or holster rig;
b. at least one channeled bracket;
c. at least one fastener;
d. at least one spacer;
e. at least one attachment fastener;
f. at least one attachment bracket; and
g. at least one adjustable torsion claw.

The instant invention is an adjustable clip system for holsters and holster rigs that allows a height or position of a holster, sheath, or holster rig to be independently adjusted in relation to a fixed attachment point on a wearer, the adjustable clip system comprising:
a. at least one channeled bracket and the at least one channel bracket having at least one first slot and at least one second slot adjacent to the at least one first slot located thereon;
b. the at least one channeled bracket being attachable to a holster using at least one attachment fastener;
c. at least one attachment bracket being slidably attached to the at least one second slot to allow the attachment bracket to slide in relation to the at least one second slot on the at least one channeled bracket while the attachment bracket remains stationary with respect to the wearer;
d. at least one adjustable fastener for slidably attaching the attachment bracket to the slotted channel of the holster and/or channeled bracket; and
e. at least one spacer being attached to the holster, channeled bracket, and/or attachment bracket by the at least one adjustable fastener.

The adjustable clip system of the instant invention wherein: the at least one attachment bracket is slidably attached to the at least one second slot of the at least one channeled bracket via at least one fastener that retains at least one spacer.

The adjustable clip system of the instant invention wherein the at least one spacer is a spring, compressible spacer, or non-compressible spacer.

The adjustable clip system of the instant invention wherein the attachment bracket and/or channeled bracket may include a textured, compressible, interlocking, or non-slip surface to increase engagement.

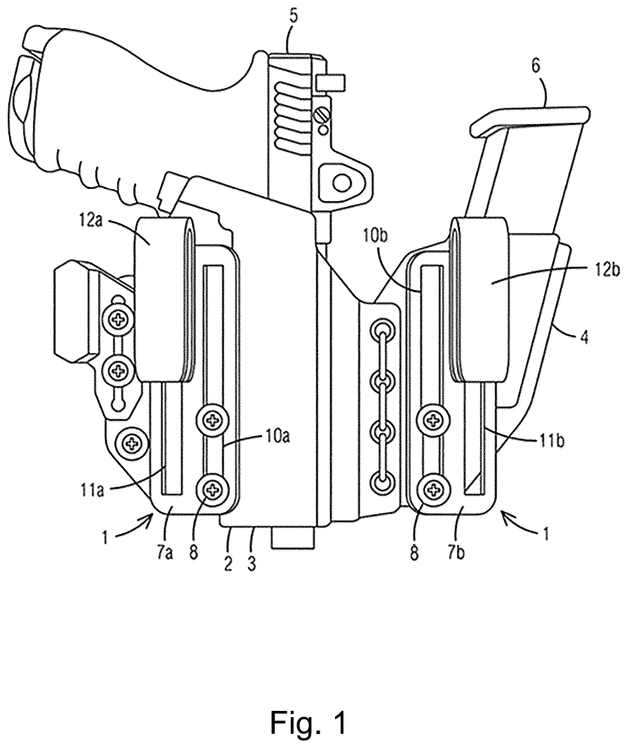

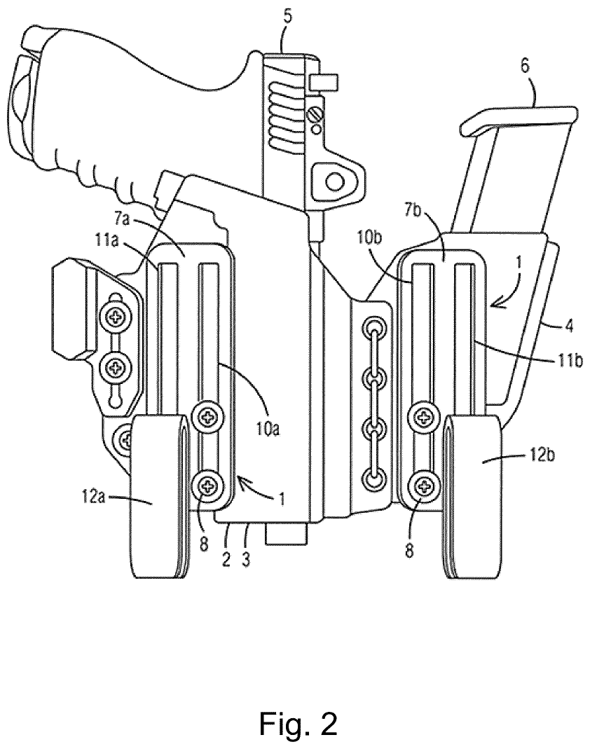

With general reference to FIGS. 1 and 2, front views of an appendix carry holster rig 2 having an adjustable clip system 1 of the present invention mounted thereto wherein the holster rig 2 is in a lowered position in FIG. 1 and in a raised position in FIG. 2 are illustrated. The appendix carry holster rig 2 comprises a holster 3 used for holding a firearm 5 attached to a magazine holder 4 used for carrying an extra magazine 6. As illustrated here, the adjustable clip system 1 comprises a first channeled member which is preferably a first channeled plate 7a and a second channeled member which is preferably a second channeled plate 7b that are attached to the holster 3 and magazine holder 4, respectively, at desired heights using an attachment fastener such as an adjustable attachment fastener 8, placed through a first opening which is preferably a first slotted channel 10a located on the first channeled plate 7a and a first opening which is preferably a first slotted channel 10b located on the second channeled plate 7b.

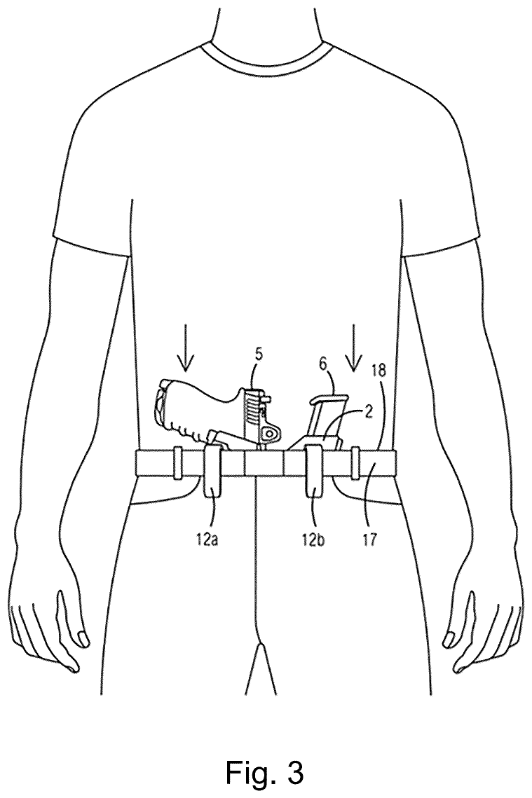

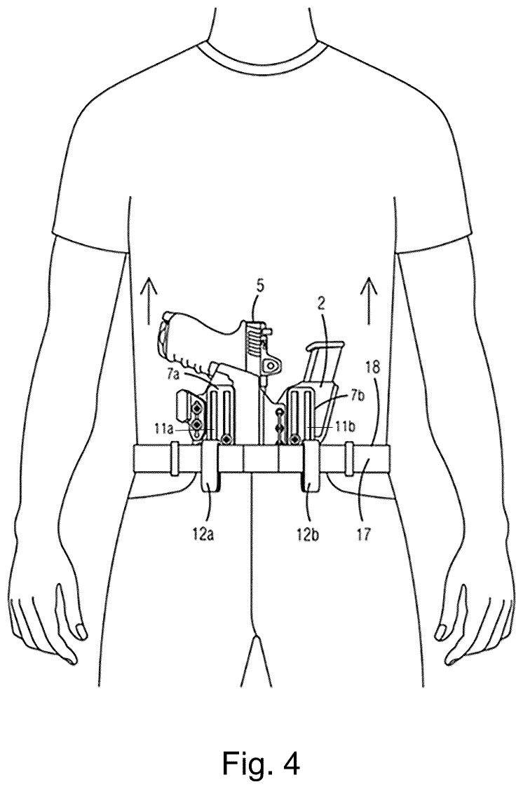

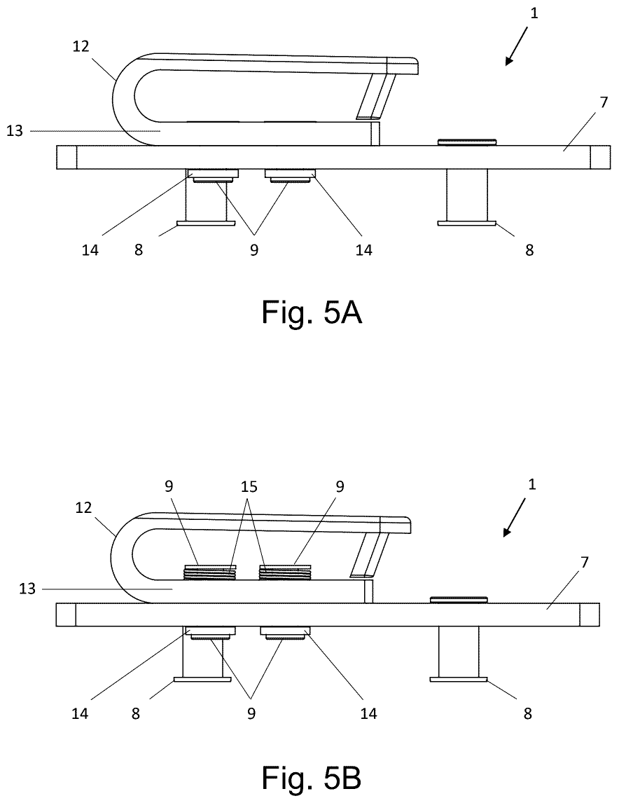

A second slotted channel 11a and a second slotted channel 11b are respectively located on the first channeled plate 7a and second channeled plate 7b. A first attachment bracket 12a and a second attachment bracket 12b are each slidably attached to the second slotted channel 11a and the second slotted channel 11b, respectively, via at least one adjustable fastener 9 and at least one spacer 14, such as a spring 15, or equivalent as illustrated in FIGS. 5A and 5B. Each spacer 14 is positioned in a manner to apply force on the channeled plates 7a or 7b and its respective attachment bracket 12a or 12b and further held in place by the at least one adjustable fastener 9. The at least one spacer 14 remains in an interfering state, thereby impeding the attachment brackets 12a and 12b from sliding in relation to their respective channeled plates 7a and 7b. Each clip or attachment bracket 12a and 12b maintain an attachment bracket base 13 and attachment bracket mount opening 16 for the at least one adjustable fastener 9 to slidably attach the attachment brackets 12a and 12b to the second slotted channel 11a and second slotted channel 11b and first channeled plate 7a and second channeled plate 7b respectively. A wearer may adjust the height or position of the holster rig 2 in relation to the attachment brackets 12a and 12b by overcoming the force of the at least one spacer 14 which causes the channeled plates 7a and 7b to slide against the attachment brackets 12a and 12b, thereby allowing the holster rig 2 to slide in relation to the attachment brackets 12a and 12b while the attachment brackets remain stationary on a waistband, belt, and/or attachment point as illustrated in FIGS. 3 and 4.

With reference to FIGS. 3 and 4, front views of an appendix carry holster rig 2 having an adjustable clip system 1 of the present invention mounted thereto and positioned at various heights on an individual's waist and abdomen are illustrated. As illustrated in FIG. 3, an individual is carrying the appendix carry holster rig 2 in a lowered position on the individual's belt 17 and waistband 18. In contrast, FIG. 4 illustrates the individual carrying the appendix carry holster rig 2 in a raised position on the individual's belt 17 and waistband 18. A wearer may adjust the height of the holster rig 2 in relation to the clips or attachment brackets 12a and 12b by applying sufficient force by means of pressing or lifting one or both of the channeled plates 7a and 7b and/or holster rig 2 attached to the channeled plates 7a and 7b in a parallel fashion in orientation to the clips 12a and 12b to overcome the force applied by the spacers 14. Force can be applied directly to the clips 12a and 12b to aid in minimizing the engagement of the spacers 14 with the channeled plates 7a and 7b. Each individual channeled plate 7a and 7b enables clips or attachment brackets 12a and 12b to translate along the length of the respective slotted channels 11a and 11b.

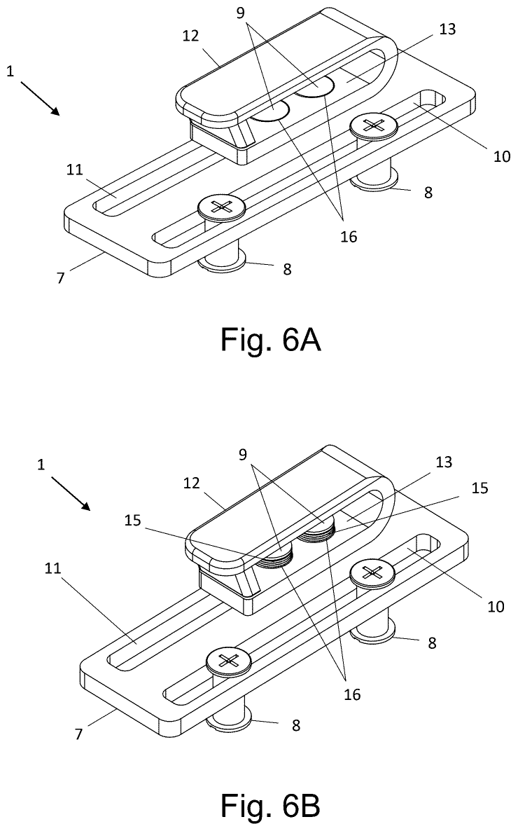

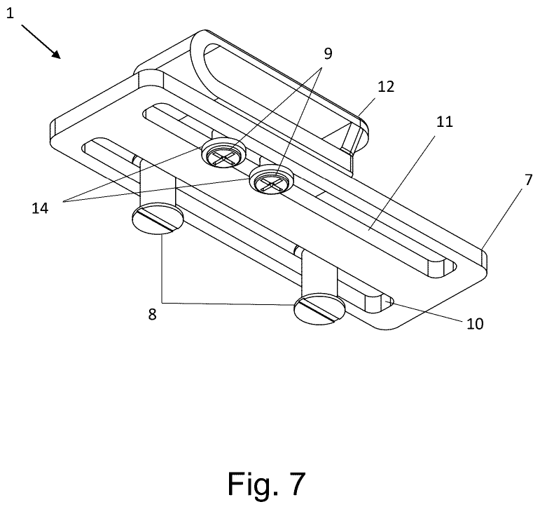

FIG. 5A is a side view of an attachment bracket, channeled plate, attachment bracket fastener, spacer, and holster attachment fastener of the adjustable clip system of the present invention. FIG. 5B is a side view of an attachment bracket, channeled plate, spring, attachment bracket fastener, spacer, and holster attachment fastener of the adjustable clip system of the present invention. FIG. 6A is a perspective view of an attachment bracket, channeled plate, attachment bracket fastener, spacer, and holster attachment fastener of the adjustable clip system of the present invention. FIG. 6B is a perspective view of an attachment bracket, channeled plate, spring, fastener, spacer, and holster attachment fastener of the adjustable clip system of the present invention. FIG. 7 is a bottom perspective view of an attachment bracket, channeled plate, attachment bracket fastener, spacer, and holster attachment fastener of the adjustable clip system.

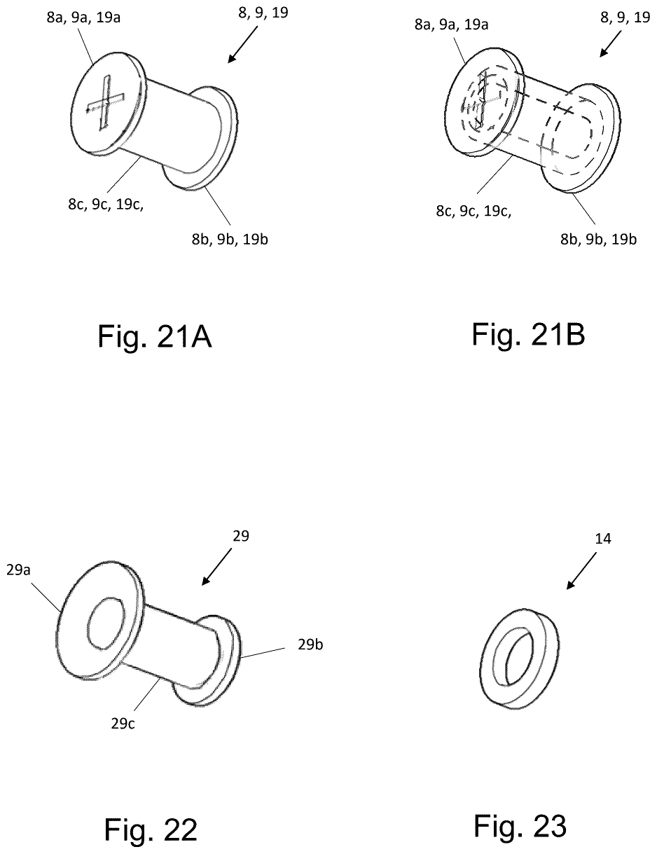

FIGS. 21A and 21B show a threaded removable rivet 8, 9, 19 having a rivet cap or first flange portion 8a, 9a, 19a engageable with a cylindrical rivet shank 8c, 9c, 19c. The cylindrical rivet pin or rivet shank 8c, 9c, 19c has a shank first end, a shank second end, and a shank flange or head 8b, 9b, 19b extending outwardly from the shank second end. The rivet cap 8a, 9a, 19a is engageable with the shank first end. In this application, any of the fasteners described above may also be a stud, threaded rivet and nut, threaded fastener, locking fastener, or ratcheting fastener.

FIG. 22 shows a permanent rivet 29 having a pin or shank 29c and a rivet head 29b. The rivet cap 29a is permanently formed during installation of the permanent rivet 29. The permanent rivet 29 or the removable rivet 8, 9, 19 may be used in any of the instances where the adjustable fastener or the attachment fastener is used. The rivet may also be a stud, threaded rivet and nut, threaded fastener, locking fastener, or ratcheting fastener. In this application, any of the rivets described above may be used as any of the fasteners found on the adjustable clip system.

The adjustable clip system according to FIG. 1-8 allows a height or position of the sheath, holster, or the holster rig to be adjusted in relation to a fixed attachment point on a wearer. The system includes a clip or attachment bracket 12 and a channeled plate 7. The channeled plate 7 may be rectangular-shaped or have any other suitable geometric shape, such as a polygon or hexagon, wherein the channeled plate 7 has a first slotted channel 10 and a second slotted channel 11 oriented parallel and/or adjacent to each other. The attachment bracket 12 is preferably U-shaped and slidably attached to the second slotted channel 11 via at least one adjustable fastener 9, which may be a stud, rivet, threaded fastener, or ratcheting fastener having head 9a and head 9b on each respective end. Head 9a and/or 9b retain the at least one spacer 14, such as a spring 15, compressible spacer, or non-compressible spacer, channeled plate 7, and clip or attachment bracket 12 together. Each clip or attachment bracket 12 maintains an attachment bracket base 13 and attachment bracket mount opening 16 for the at least one adjustable fastener 9 to slidably attach the attachment bracket 12 to the slotted channel 11 and the channeled plate 7 respectively. The channeled plate 7 and attachment bracket 12 may maintain interlocking notches, textured or compressible surfaces, or non-slip ridges to provide intermediate adjustment points for slidably fixing the clip or attachment bracket in place along the length of either slotted channel of channeled plate 7. Each channeled plate 7 may be attached to the holster or sheath 3, 4 by at least one adjustable attachment fastener 8.

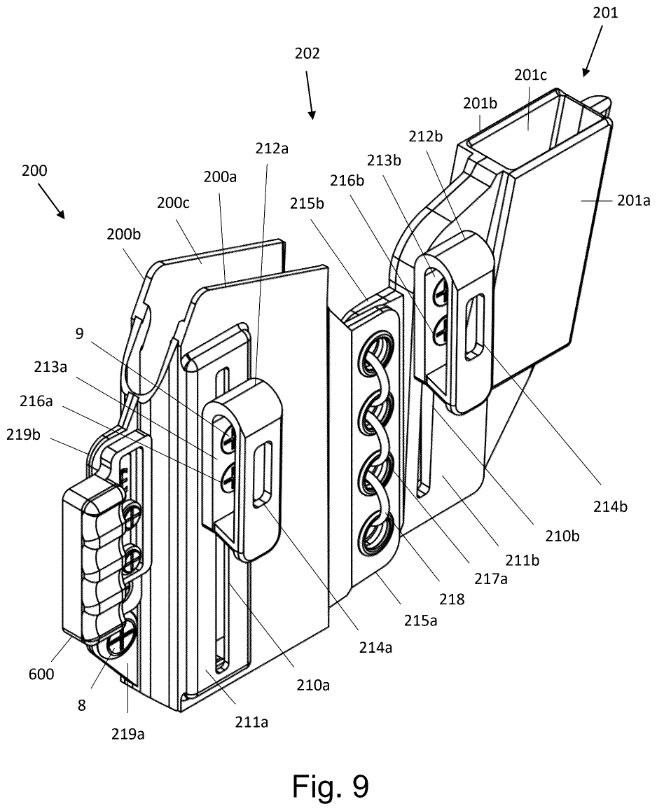

Referring to the drawings FIGS. 9-14, there is shown a second embodiment of the present invention. FIG. 9 shows a perspective view from the front side of a holster rig 202 including a holster 200 and a second holster 201, the holster rig 202 showing a first holster slot 210a and a second holster slot 210b. The first holster slot 210a and second holster slot 210b may be milled into an existing holster or holster rig, or may be manufactured with the first holster slot 210a and second holster slot 210b in the holster or holster rig. A first adjustable clip or attachment bracket 212a is slidably installed in the first holster slot 210a and a second clip or attachment bracket 212b is slidably installed in the second holster slot 210b. The adjustable clip system is securable to a sheath or holster for allowing a height or position of the sheath or holster to be adjusted in relation to a fixed attachment point on a wearer. The adjustable clip system includes at least one clip or attachment bracket 212a, 212b, at least one adjustable fastener 9, the adjustable fastener 9 preferably being a threaded rivet or removable rivet 8, 9, 19 (FIGS. 21A and 21B), comprising a first flange 9a having a threaded cap engageable with an integrated threaded cylinder 9c protruding therefrom and a second flange 9b. The adjustable fastener 9 extends through the holster slot 210a, 210b on the sheath or holster and through a mount opening 216a, 216b on the mounting portion 213a, 213b respectively of the adjustable clip or attachment bracket 212a, 212b, for slidably securing the clip or attachment bracket 212a, 212b to the sheath or holster. The adjustable clip system includes at least one spacer 14 disposed between a first flange 9a or second flange 9b (FIGS. 21A and 21B) of the adjustable fastener 9 and the surface of the sheath or holster adjacent the holster slot 210a, 210b. The at least one spacer remains in an interfering state, thereby locking the channeled plates and respective clips or attachment brackets together. The spacer may be a spring, compressible spacer, or non-compressible spacer. The position adjustable holster 200, 201, or holster rig 202 may include a textured, compressible, interlocking, or non-slip surface on a surface of the attachment bracket 212a, 212b and/or channel member 211a, 211b.

The user of the holster 200, 201, or holster rig 202 can adjust the height and/or position of the holster by grasping the base or other part of the holster and urging the holster along the direction of the holster slot 210a, 210b integrated into the holster, whereby the holster translates along the path of the holster slot channel 210a, 210b.

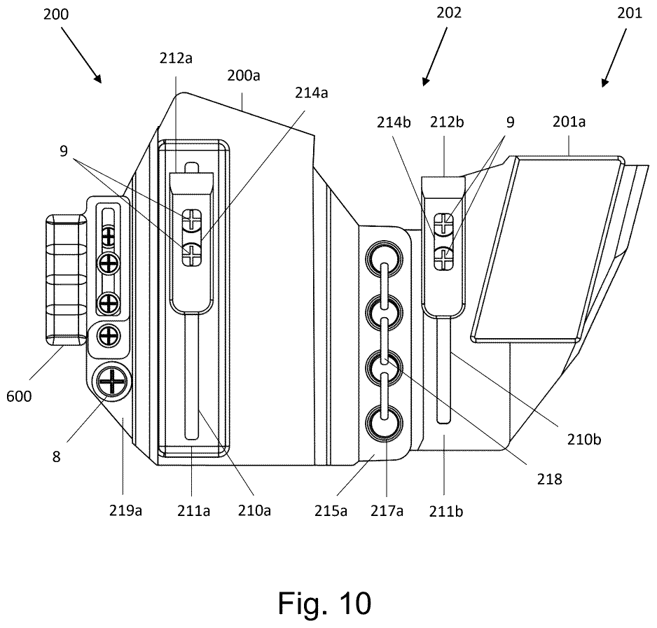

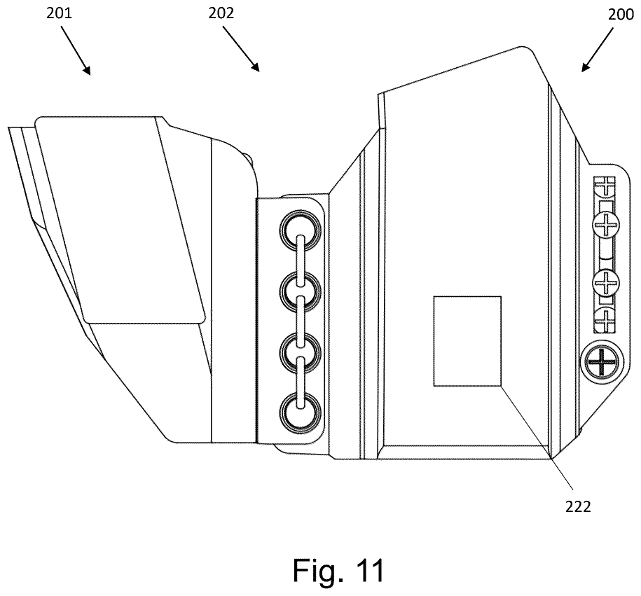

Holster 200, 201, holster rig 202 shown in FIG. 10 includes the first adjustable clip or attachment bracket 212a which is installed in the first holster slot 210a and the second adjustable clip or attachment bracket 212b which is installed in the second holster slot 210b. FIG. 11 shows a rear view of a Holster 200, 201, holster rig 202 whereas an electronic module 222 may be installed in the holster and/or adjustable clip system for automating adjustments to the fasteners, spacers, attachment brackets, and/or holster, and/or communicating data to a device.

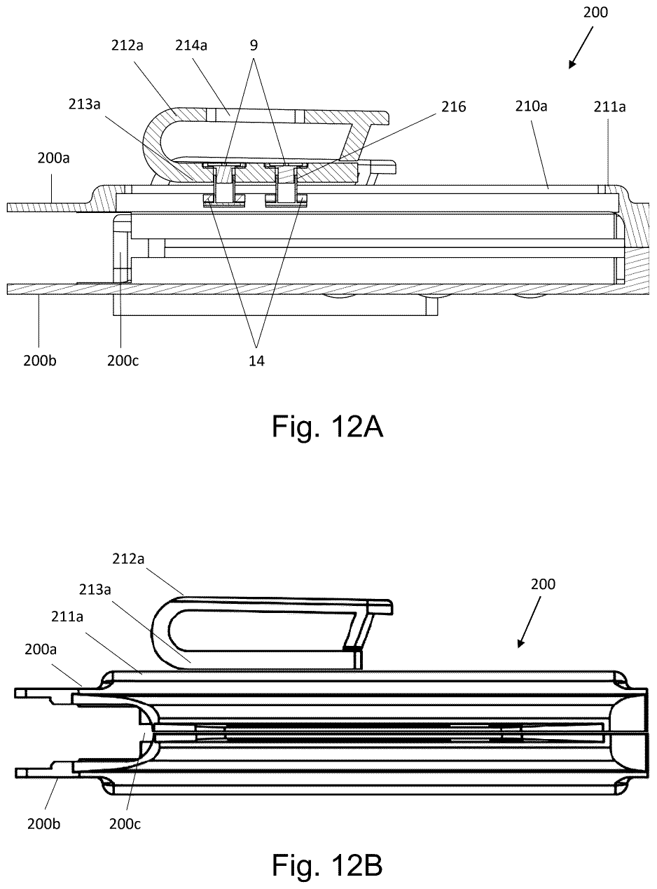

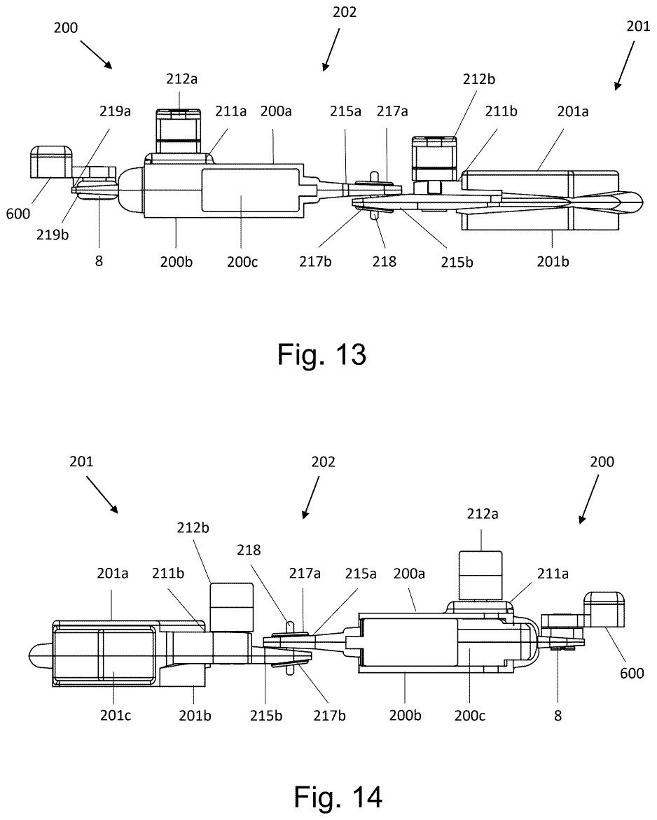

FIG. 12A shows a lateral sectional side view of a portion of the holster including the first holster slot 210a. Referring to FIG. 12B is shown a side view of the holster 200 showing the attachment bracket 212a which is installed in first holster slot 210a. Referring to FIG. 13 is shown a bottom view of holster 200, 201, and holster rig 202, showing the first adjustable clip or attachment bracket 212a and the second adjustable clip or attachment bracket 212b installed respectively in the first holster slot 210a and the second holster slot 210b. Holster 200 and holster 201 are adjustably bound together by a binding material 218 through holster binding holes 217a and 217b via a first holster extension 215a and 215b, respectively. A second holster extension 219a and 219b provide a surface to retain an alternative adjustable torsion claw 600 to the holster 200 via an accessory channel 221a and an accessory channel 221b. Retention adjustment holes 220a, 220b are located adjacent the holster extension 219a, 219b through which a fastener 9 and spacer 14 may be used to adjust the retention of a firearm or tool. Referring to FIG. 14 is shown a top view of holster 200, 201 and holster rig 201, showing the first adjustable clip or attachment bracket 212a and the second adjustable clip or attachment bracket 212b installed respectively in the first holster slot 210a and the second holster slot 210b.

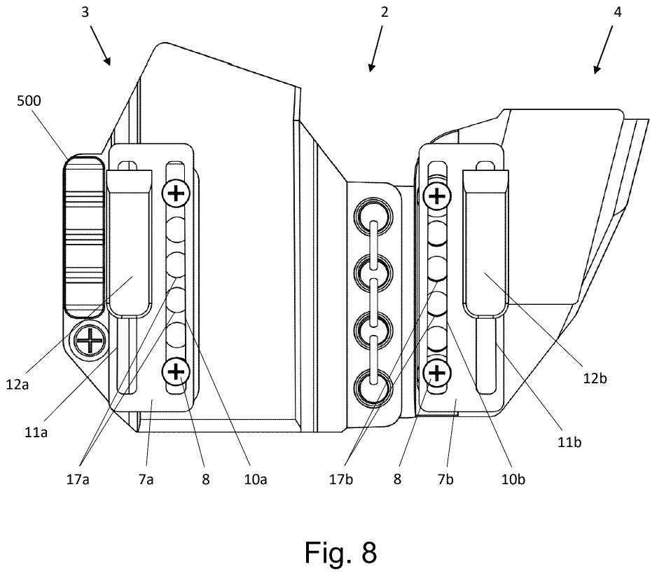

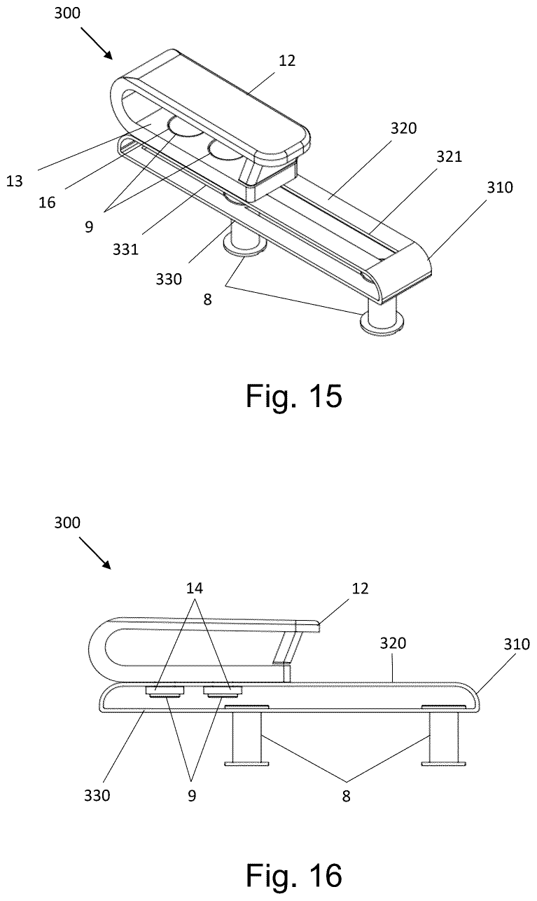

FIG. 15 is a perspective view of an alternative embodiment of the adjustable clip system 300 including a belt clip or attachment bracket 12 and a channeled member which is preferably a channel bracket 310 which engages with at least one adjustable fastener 8 through second channel bracket slot 331 on channel 330 shown in FIG. 15 with holes 17a, 17b as shown in FIG. 8 to secure channel bracket 310 to holster 3. The attachment bracket 12 is attached to the channel bracket 310 via an at least one fastener 9 through first channel bracket slot 321 which has spacer 14 captured between the first stud head and the underside of channel 320. A spacer 14 or spring 15 may also be disposed between the fastener second flange opposite the fastener first flange and the mounting portion 13 of attachment bracket 12. The attachment bracket 12 has an attachment bracket mount opening 16 which the fastener 9 is enabled to fit through. The fastener 9 fits in the first channel bracket slot 321 of channel bracket 310. Rivets, studs, or other fasteners are used to attach the channel bracket 310 to the holster 3, 4, which extend through second channel bracket slot 331 and engage with channel 330 shown in FIG. 15 or with holes 17a and 17b as shown in FIG. 8. The spacer 14 or spring 15 allows the attachment bracket 12 to slide in the first channel bracket slot 321 on channel bracket 310. When the user applies force to the holster 3, 4, or holster rig 2 that the channel bracket 310 is attached, the spacers 14 or springs 15 compress to allow the fasteners 9 to slide in the first channel bracket slot 321 on channel bracket 310, thereby allowing the attachment brackets 12a, 12b to be adjusted along the length of channel 320. Referring to FIG. 16 is shown the channel bracket 310 viewing the channel 330 which contacts the sheath or holster 3, 4. First channel bracket slot 321 allows sliding movement of the fastener 9. The channel bracket 310 is mounted to the sheath or holster 3, 4. The at least one spacer remains in an interfering state, thereby locking the channeled brackets and respective clips together.

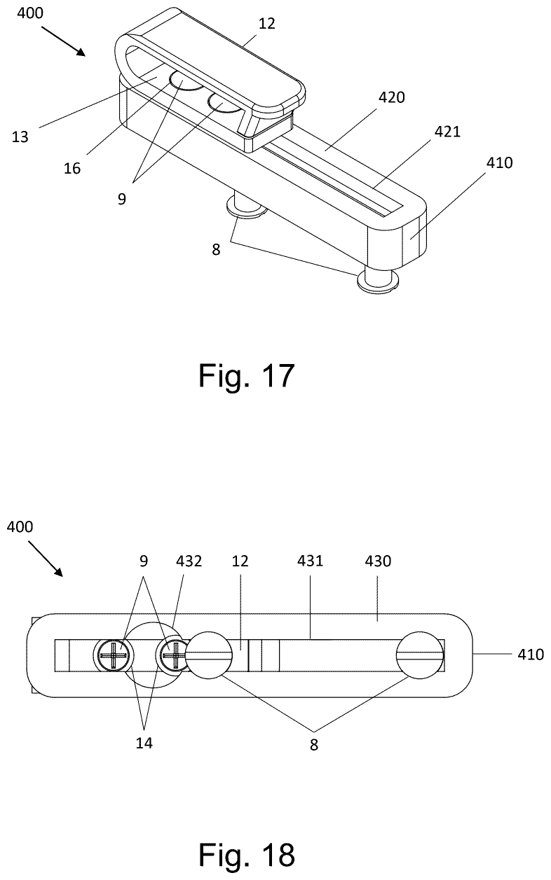

Referring to FIG. 17 is a perspective view of an alternative adjustable clip system 400 including an attachment bracket 12 and a channeled member which is preferably a surface mount channel bracket 410 which attaches to the holster 3, 4 with fasteners or stud 9 through lower channel 430. The attachment bracket 12 is slidably attachable to the surface mount channel bracket 410 using at least one fastener 9 passing through a first surface mount channel bracket slot 421 with which have spacers 14 or springs 15 captured between the second fastener flange and the underside of upper channel 420. Attachment bracket 12 has a mount opening 16 on attachment bracket base 13 in which the fastener 9 is enabled to fit through. The at least one spacer 14 remains in an interfering state, thereby locking the surface mount channeled bracket 410 and attachment bracket 12 together. When the user applies force to the holster 3, 4 that the surface mount channel bracket 410 is attached to, spacer 14 or spring 15 retained by fastener 9 on attachment bracket 12 allows the adjustable fasteners 9 to slide freely in first surface mount channel bracket slot 421, thereby allowing the attachment bracket 12 to be adjusted along first surface mount channel bracket slot 421. Referring to FIG. 18, there is shown a back view of the surface mount channel bracket 410 showing second surface mount channel bracket slot 431, fastener 9, and lower channel 430 which contacts the sheath or holster. A surface mount channel bracket base opening 432 allows for the ease of installation of fastener 8 for attachment to holster 3, 4, or holster rig 2.

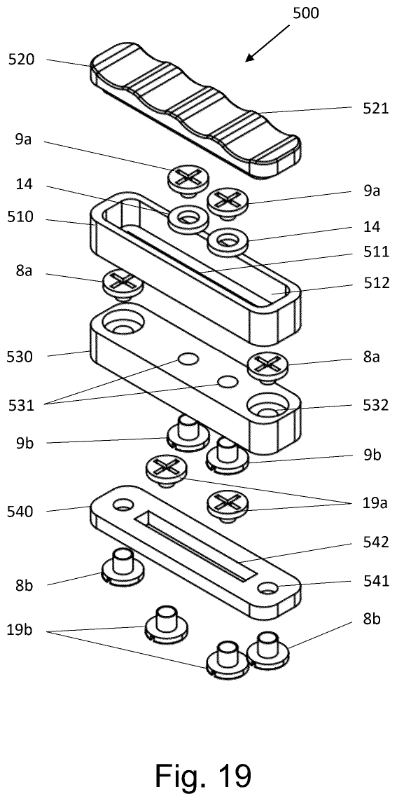

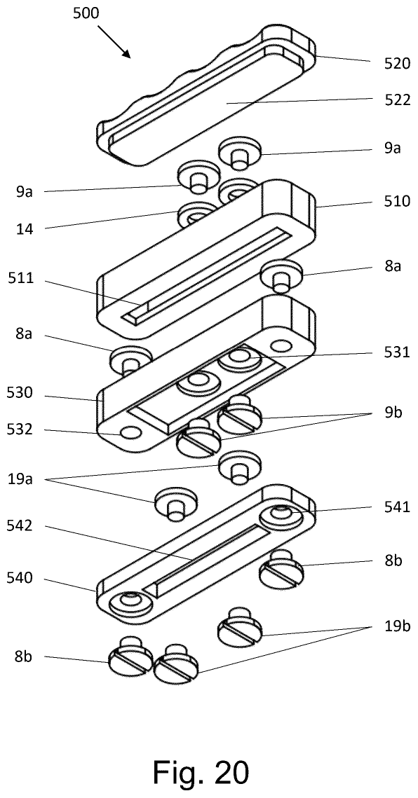

FIGS. 8, 19, and 20 is directed to an adjustable torsion claw 500 securable to a sheath or holster for allowing a height or position of the torsion claw 500 to be adjusted in relation to the holster or sheath 3, 4, 200, 201, or holster rig 2, 202. The adjustable torsion claw 500 reduces the impression imposed by the mass of a firearm or tool worn under clothing such as a shirt, sweater, or jacket. The impression caused by the mass of the tool or firearm is commonly referred to as “printing”. The adjustable torsion claw 500 minimizes printing by torquing the firearm and/or holster 3, 4, 200, 201 and/or holster rig 2, 202 against the user's belt or garment, aligning the firearm more closely with the user's body. Adjustable torsion claw 500 accommodates for changes in height and/or position of the holster 3, 4, 200, 201, or holster rig 2, 202 while maintaining torsion of the sheath, holster, or holster rig. The adjustable torsion claw 500 includes an adjustable torsion claw bracket 510 slidably attached to an adjustable torsion claw upper mounting base 530 using adjustable fasteners 9 through an adjustable torsion claw slot 511 located in an adjustable torsion claw bracket groove 512. Fastener 9 may engage a spacer 14 or spring 15 for adjusting the amount of engagement between the adjustable torsion claw bracket 510 and the adjustable torsion claw upper mounting base 530. Adjustment fastener 9 urges the adjustable torsion claw bracket 510 toward the adjustable torsion claw upper mounting base 530 to allow the adjustable torsion claw bracket 510 to slide along the adjustable torsion claw upper mounting base 530 when sufficient force is applied to the adjustable torsion claw bracket 510 along the length of adjustable torsion claw slot 511. The adjustable clip system is securable to a sheath or holster 3, 4, 200, 201, or holster rig 2, 202 for allowing a height or position of the sheath or holster 3, 4, 200, 201, or holster rig 2, 202 to be adjusted in relation to a fixed attachment point on a wearer. The adjustable torsion claw 500 includes the adjustable torsion claw bracket 510 having the adjustable torsion claw slot 511 within the adjustable torsion claw bracket groove 512, an adjustable torsion claw cap 520 having a textured torsion claw cap surface 521 thereof, the adjustable torsion claw cap 520 securable to the adjustable torsion claw bracket 510 by a torsion claw cap extension 522. The torsion claw cap extension 522 extends from a surface of the adjustable torsion claw cap 520 thereof, attaches the adjustable torsion claw cap 520 to the adjustable torsion claw bracket 510 by locking into the adjustable torsion claw bracket groove 512. The textured torsion claw cap surface 521 may have ridges or a non-slip texture on a surface. The adjustable torsion claw 500 includes the adjustable torsion claw upper mounting base 530 wherein the adjustable torsion claw bracket 510 slidably secures the adjustable torsion claw cap 520 to the adjustable torsion claw upper mounting base 530 and an adjustable torsion claw lower mounting base 540 for mounting the adjustable torsion claw upper mounting base 530 to the sheath or holster 3, 4, 200, 201, or holster rig 2, 202. The adjustable torsion claw mounting base 540 maintains an adjustable torsion claw base mounting slot 542 for attaching the adjustable torsion claw mounting base 540 to the sheath or holster 3, 4, 200, 201, or holster rig 2, 202 through the use of at least one adjustable attachment fastener 8. The adjustable torsion claw system 500 includes at least one adjustable fastener 9, comprising a first flange having an integrated threaded cylinder protruding therefrom and a second flange engageable with the threaded cylinder. The adjustable fastener 9 extends through the adjustable torsion claw slot 511 and at least one opening 530 in the adjustable torsion claw upper mounting base 530, for securing the adjustable torsion claw cap 520 to the adjustable torsion claw upper mounting base 530. Attachment fasteners 19 secure the adjustable torsion claw upper mounting base 530 to the adjustable torsion claw lower mounting base 540 through a respective opening 541 and opening 532. The adjustable clip system includes at least one spacer 14 disposed between the first flange of the adjustable fastener 9a and inside surface of adjustable torsion claw bracket 510. The adjustable fastener shank 9c extending through the adjustable torsion claw slot 511 and the adjustable torsion claw upper retaining holes 531, the second flange of the adjustable fastener 9b disposed on the adjacent side of the adjustable torsion claw upper mounting base 530 to slidably retain the adjustable torsion claw bracket 510. Turning the adjustable fastener head 9a in one direction increases engagement and decreases slidability while turning the adjustable fastener head 9a in the opposite direction decreases engagement and increases slidability of the adjustable torsion claw bracket 510. This adjustability holds true for all embodiments of the adjustable clip system described herein. Adjustability for both fine adjustment changes due to wear of the components and user preference for handling holds true for any sliding part described herein. The threaded rivet shown in FIGS. 21A and 21B may be used in this embodiment of the adjustable torsion claw system. The at least one fastener 8, 9, 19 may be a stud, rivet, threaded rivet and nut, threaded fastener, or ratcheting fastener. The alternative adjustable torsion claw base 510 and/or adjustable torsion claw upper mounting base 530 may maintain interlocking notches, textured or compressible surfaces, or non-slip ridges to provide intermediate adjustment points for slidably fixing the adjustable

The channeled member described herein may be a channeled plate: slotted channel 10a, 10b, 11a, 11b; holster slot 210a, 210b; accessory channel 221a, 221b; channel bracket slots 321, 331; surface mount channel bracket slot 421, 431; adjustable torsion claw slot 511; adjustable torsion claw base mounting slot 542; adjustable torsion claw mounting slot 612; and, channel plate slot 730. Although each of the items, slotted channel 10a, 10b, 11a, 11b; holster slot 210a, 210b; accessory channel 221a, 221b; channel bracket slots 321, 331; surface mount channel bracket slot 421, 431; adjustable torsion claw slot 511; adjustable torsion claw base mounting slot 542; adjustable torsion claw mounting slot 612; and, channel plate slot 730 include one or more channels or slots, the channels or slots may present in different orientations or on different planes.

The use of the term “hole”, “opening”, “channel”, or “slot” in reference to the attachment or mounting of any embodiment within this disclosure herein described including slotted channel 10a, 10b, 11a, 11b; holster slot 210a, 210b; accessory channel 221 a, 221b; channel bracket slots 321, 331; surface mount channel bracket slot 421, 431; adjustable torsion claw slot 511; adjustable torsion claw base mounting slot 542; adjustable torsion claw mounting slot 612; and, channel plate slot 730 may take the form of a hole or exist on different planes, orientations, or quantities. The pattern for mounting of any of the embodiments herein may be rearranged to facilitate various patterns for attachment to holsters, holster rigs, and sheaths maintaining different attachment footprints.

FIGS. 21A and 21B show a threaded rivet 8, 9, 19 comprising a first flange 8a, 9a, 19a having an integrated threaded cylinder 8c, 9c, 19c protruding therefrom and a second flange 8b, 9b, 19b engageable with the threaded cylinder 8c, 9c, 19c. As shown in FIG. 22, a non-removable rivet 29 includes a first flange 29a integrated with a cylindrical shank or shaft 29c. The cylindrical shaft has a formable portion at the end of the shaft 29c opposite the first flange 29a which is pressed outward into the second flange 29b. FIG. 23 shows one embodiment of the spacer 14 which is preferably a compressible spacer, and may be a non-compressible spacer, or spring 15.

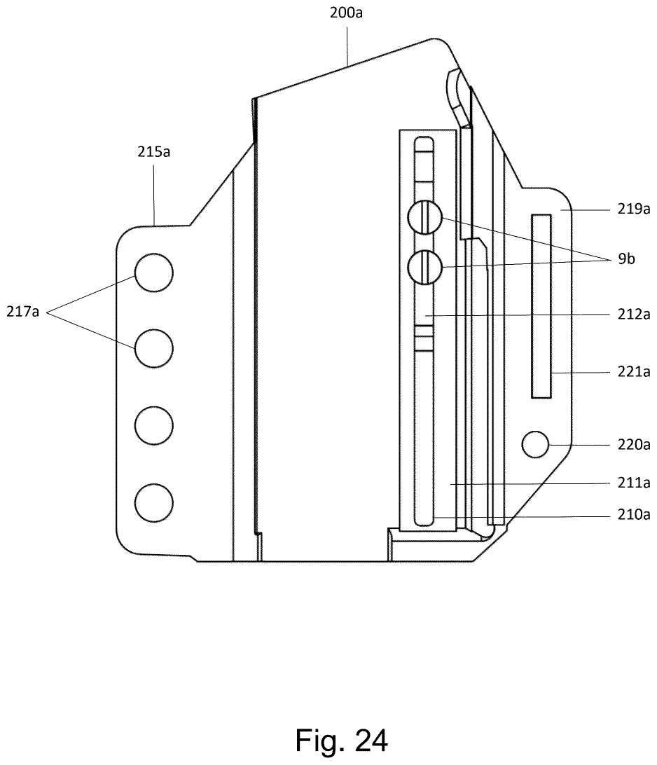

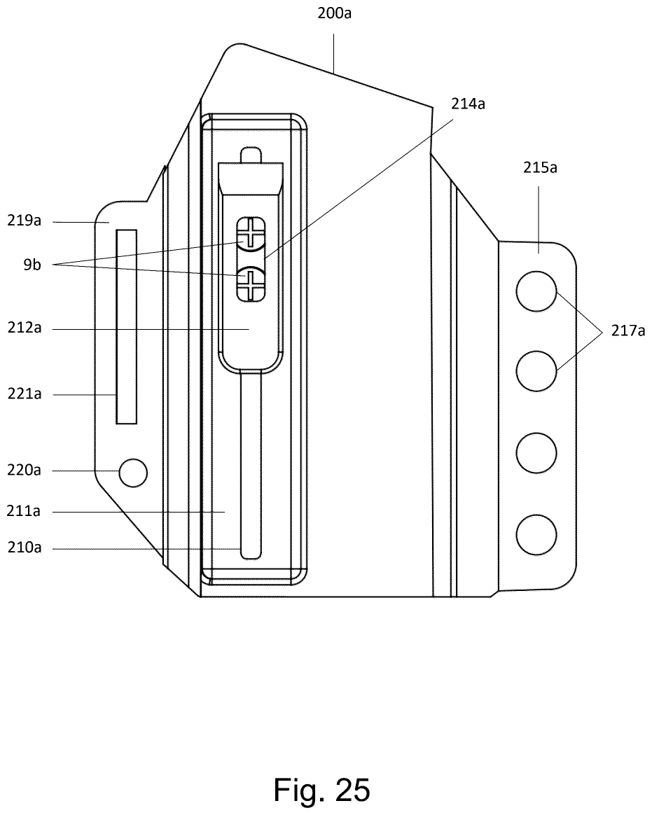

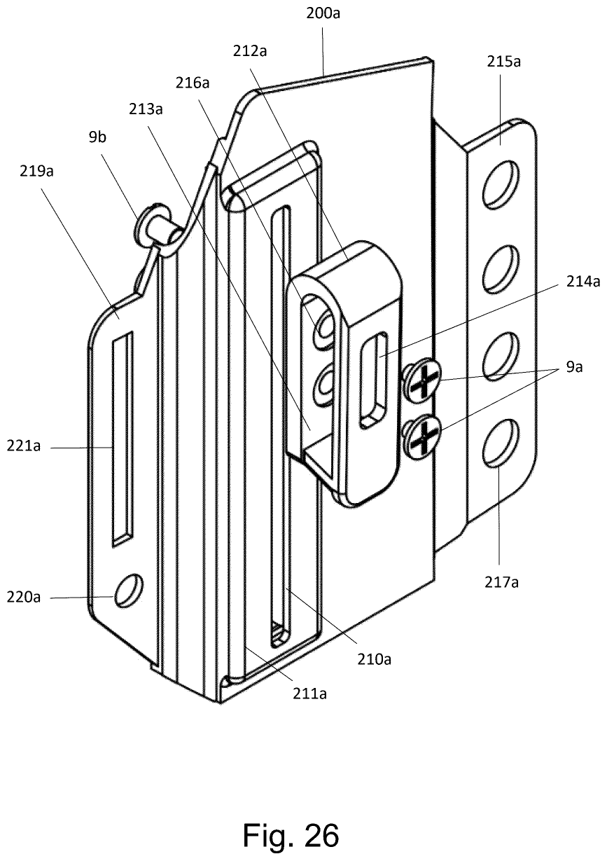

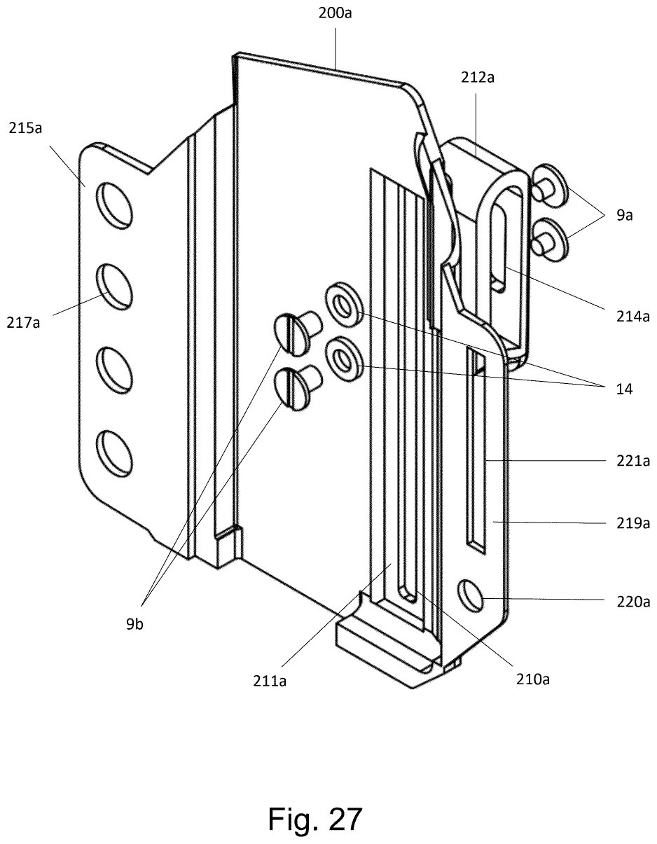

Another aspect of the present invention as best seen in FIGS. 9-14 and FIGS. 24-27 is directed to a method for installing an adjustable clip system securable to a holster or sheath 200, 201, or holster rig 202 for allowing a height of the holster or sheath 200, 201, or holster rig 202 to be adjusted in relation to a fixed attachment point on a wearer. The method includes providing the holster or sheath 200, 201, or holster rig 202 and ensuring the holster or sheath 200, 201, or holster rig 202 has an elongated slot 210a, 210b disposed vertically on a portion of the holster or sheath 200, 201, or holster rig 202. The method includes providing an attachment bracket which is preferably a U-shaped clip 212a, 212b, the U-shaped clip 212a, 212b having a mounting portion 213a, 213b with at least one mount opening 216a, 216b as shown in FIG. 26. The method includes providing a threaded rivet or adjustment fastener 9 as shown in FIGS. 21A and 21B, having a stud portion 9c with a first stud end and a second stud end opposite the first stud end. The adjustment fastener 9 has a head portion 9a removably attachable to the stud first end and a base portion 9b attached to the stud second end. The method includes providing a spacer 14, ensuring the fastener head 9a has been removed from the fastener stud 9c and extending the first end of the fastener stud 9c through the spacer 14 until the fastener base portion 9b contacts the spacer 14. The method includes extending the first end of the fastener stud 9c through the holster slot 210a, 210b until the spacer 14 contacts the holster or sheath 200, 201, or holster rig 202, extending the first end of the fastener stud 9c through the mount opening 216 and engaging the fastener head portion 9a to the first stud end. The method includes tightening the fastener head portion 9a onto the stud first end, securing the attachment bracket 212a, 212b to the wearer's belt or waistband, and adjusting the holster or sheath 200, 201, or holster rig 202 along the length of the holster slot 210a, 210b. The fastener head can be adjusted to increase or decrease engagement and drag to add or reduce resistance between the attachment bracket 212a, 212b, the channel member 211a, 211b, and spacer 14 or spring 15 for sliding of the fastener 9 and attachment bracket 212a, 212b along the holster slot 210a, 210b. In an alternate method, the steps which include engagement of the fastener 9 may be reversed wherein the engagement steps include ensuring the fastener head 9a has been removed from the fastener stud 9c, extending the first end of the fastener stud through the clip mounting opening 216a, 216b until the second end of the stud 9b contacts the mounting portion of the u-shaped clip or attachment bracket 212a, 212b, extending the first end of the fastener stud 9c through the holster slot 210a, 210b in the holster 200, 201 respectively, extending the first end of the stud through the spacer 14 or spring 15, and engaging the fastener head 9a with the stud portion of the fastener 9c. The fastener head 9a can be adjusted to increase or decrease engagement and drag to add or reduce resistance between the attachment bracket 212a, 212b, the channel member 211a, 211b, and spacer 14 or spring 15 for sliding of the fastener 9a and attachment bracket 212a, 212b along the holster slot 210a, 210b. The user may then don the holster 200, 201, or holster rig 202 by attaching the attachment bracket 212a, 212b to the user's desired attachment point and adjust the holster 200, 201, or holster rig 202 along the length of the holster slots 210a, 210b to the functional position of comfort. The at least one fastener 9 may be a stud, rivet, threaded rivet and nut, threaded fastener, or ratcheting fastener.

An electronic module 222 as shown in FIG. 11 may be mounted to a portion of the holster, sheath, holster rig, or adjustable clip system in order to automate adjustment of the fasteners and/or compression washers or springs to increase or decrease engagement of the adjustable clip system and/or adjustable torsion claw. The electronic module may also be used to trigger an actuator, sensor, and/or transducer to adjust the height of the clip along the channeled member and/or retention of the clips and/or weapon/tool being carried. The electronic module may be equipped with a wireless device and may be controlled through technology including but not limited to a Bluetooth module via cellphone or other electronic device. The controls include but are not limited to locking/retention features for the holster or adjustable clip system, sensors for measuring position and force of engagement, communication with actuators, sensors, and transducers for the automated movement of the clips and/or channeled members, and the delivery of error messages or other technical information. User data may be obtained for the purpose of but not limited to diagnostics, feedback, and troubleshooting.

Another aspect of the present invention is directed to a position adjustable holster or sheath 200, 201, or holster rig 202 shown in FIGS. 9-14, and the position adjustable holster or sheath first side shown in FIGS. 26-29. The position adjustable holster or sheath 200, 201 of FIG. 9-14 includes a housing first side 200a, 201a and a housing second side 200b, 201b. The adjustable position holster or sheath 200, 201 may be bound with a binding material 218 through binding holes 217a, 217b extending from a first holster extension 215a, 215b on a first housing side 200a, 201a of the position adjustable holster and a second housing side 200b, 201b of the position adjustable holster respectively. The combination of the housing first side 200a, 201a and the housing second side 200b, 201b may alternately be a single-continuous piece which forms a holster compartment. The position adjustable holster or sheath 200, 201 includes a compartment 200c, 201c for placement of a tool, the compartment 200c, 201c formed by the housing first side 200a, 201a and the housing second side 200b, 201b respectively. The tool can be a firearm, firearm magazine, knife, flashlight, tourniquet, container, or other tool. The position adjustable holster or sheath 200, 201 includes a channel member 211a, 211b disposed on a first length of the housing first side 200a, 201a respectively. The binding of holster 200, 201 with binding material 218 through holes 217a, 217b form the holster rig 202. The channel member 211a, 211b having a holster slot 210a, 210b extending along a second length of the channel member 211a, 211b respectively. The position adjustable holster or sheath 200, 201 includes at least one attachment bracket 212a, 212b being slidably attached to the holster slot 210a, 210b to allow the attachment bracket 212a, 212b to slide along the second length of the holster slot 210a, 210b in relation to the housing first side 200a, 201a respectively, the attachment bracket 212a, 212b remaining stationary with respect to the wearer. The position adjustable holster or sheath 200, 201 includes at least one attachment bracket fastener 9 extending through a mount opening 216a, 216b in a mounting portion 213a, 213b of the attachment bracket 212a, 212b and through the holster slot 210a, 210b wherein the attachment bracket fastener 9 secures the at least one attachment bracket 212a, 212b slidably to the channel member 211a, 211b. The position adjustable holster or sheath 200, 201 may include an accessory channel 221a, 221b extending from a second holster extension 219a, 219b of the position adjustable holster or sheath 200, 201, the accessory channel 221a, 221b for adjustably securing an accessory to the position adjustable holster or sheath 200, 201 on the wearer. The channel member 211a, 211b may include a textured, interlocking, compressible, or non-slip surface. The channel member 211a, 211b may be a raised portion of the housing first side 200a, 201a. The at least one attachment bracket fastener 9 may be an at least one stud 29 for retaining a spacer 14 or spring 15 for slidably attaching the attachment bracket 212a, 212b to the holster slot 210a, 210b respectively. The at least one attachment bracket fastener 9 may be a stud, rivet, threaded rivet and nut, threaded fastener or ratcheting fastener as shown in FIGS. 21A, 21B, and 22 having a first flange on a first end integrated with a threaded cylinder and a second flange disposed on a second end opposite the first end, the second flange engageable with the threaded cylinder. The at least one spacer 14 may be a spring, compressible spacer, or non-compressible spacer. The attachment bracket 212a, 212b may include a bracket opening 214a, 214b for accessing the at least one attachment bracket fastener 9. The position adjustable holster 200, 201 may include a textured, compressible, interlocking, or non-slip surface on a side of the attachment bracket 212a, 212b and/or channel member 211a, 211b.

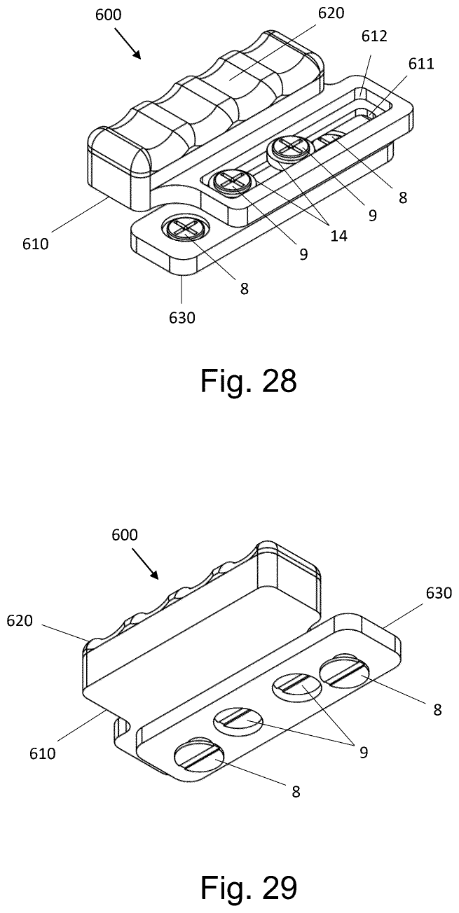

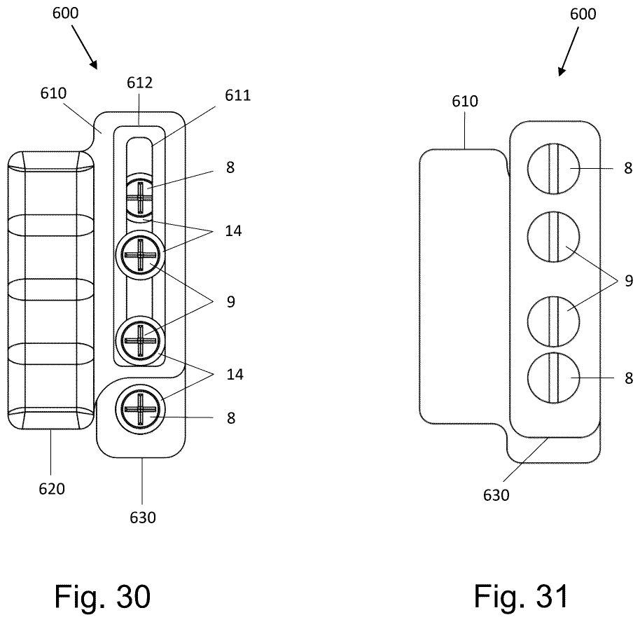

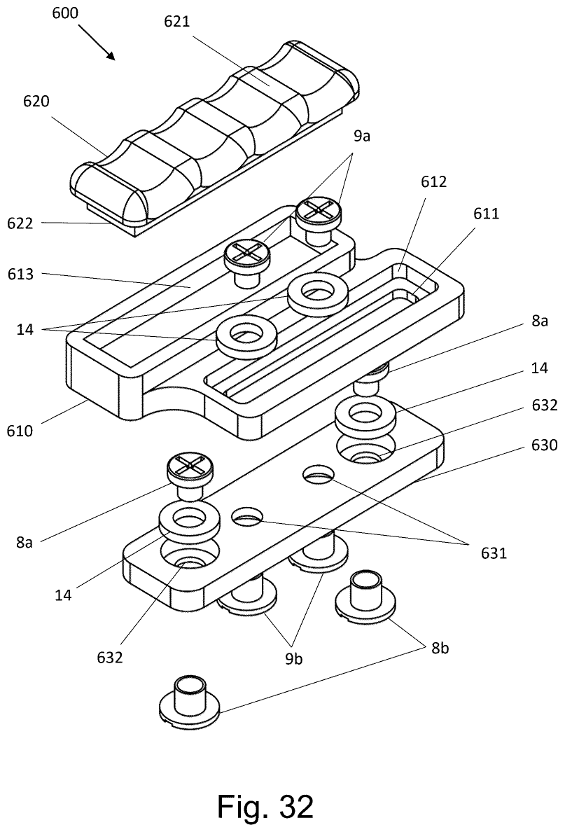

Another aspect of the present invention shown in FIGS. 28-32 is directed to an alternative adjustable torsion claw 600 securable to a sheath or holster for allowing a height or position of the alternative adjustable torsion claw 600 to be adjusted in relation to the sheath or holster. The alternative adjustable torsion claw 600 includes a torsion claw base 610 having a torsion claw base slot 611, disposed in a torsion claw base groove 612 of the torsion claw base 610. A torsion claw face 620 having a textured surface 621, is disposed in a torsion claw groove 613 of the torsion claw base 610 by a torsion claw face extension 622 extending from a surface of the torsion claw face 620. The alternative adjustable torsion claw 600 includes a torsion claw mounting base 630 for slidably mounting the torsion claw base 610 to the sheath or holster, the torsion claw mounting base 630 including at least one fastener opening 631. The alternative adjustable torsion claw 600 includes at least one torsion claw fastener 9 extending through a torsion claw base slot 611 for slidably fastening the torsion claw base 610 to the torsion claw mounting base 630, the at least one torsion claw fastener 9 including a first flange as shown in FIGS. 21A, 21B, and 22 having a threaded cylinder protruding therefrom and a second flange engageable with the threaded cylinder, the at least one torsion claw fastener 9 extending through the torsion claw base slot 611 in the torsion claw base 610. The alternative adjustable torsion claw 600 includes at least one spacer 14 disposed between the first flange of the torsion claw fastener 9 and the torsion claw base slot 611 to slidably attach the torsion claw base 610 to the torsion claw mounting base 630. The alternative adjustable torsion claw 600 may include a mounting base fastener 8 for securing the torsion claw mounting base 630 to the sheath or holster through at least one torsion claw fastener opening 632 in the torsion claw mounting base 630. The alternative adjustable torsion claw 600 may include a textured, compressible, interlocking, or non-slip surface on the torsion claw base 610 and/or torsion claw mounting base 630 adjacent. The at least one spacer 14 may be a spring 15, compressible spacer, or non-compressible spacer. The at least one fastener 9 and the at least one mounting base fastener 8 may be a stud, rivet, threaded rivet and nut, threaded fastener, or ratcheting fastener. The at least one fastener 8 may be a torsion claw mounting base fastener for securing the torsion claw mounting base to the sheath or holster.

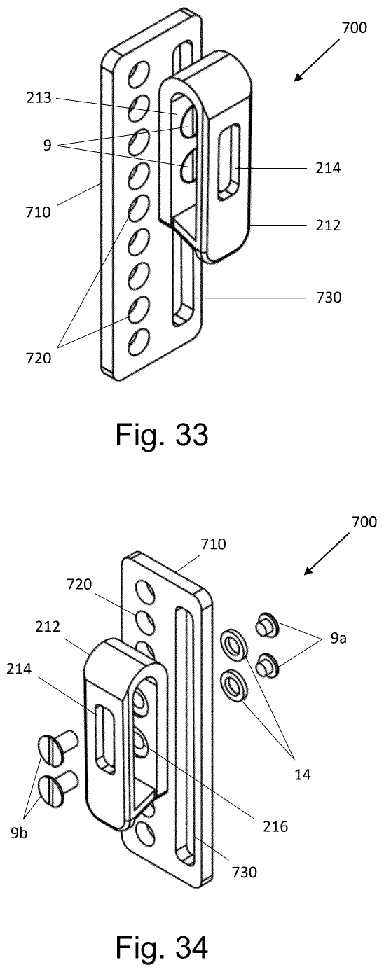

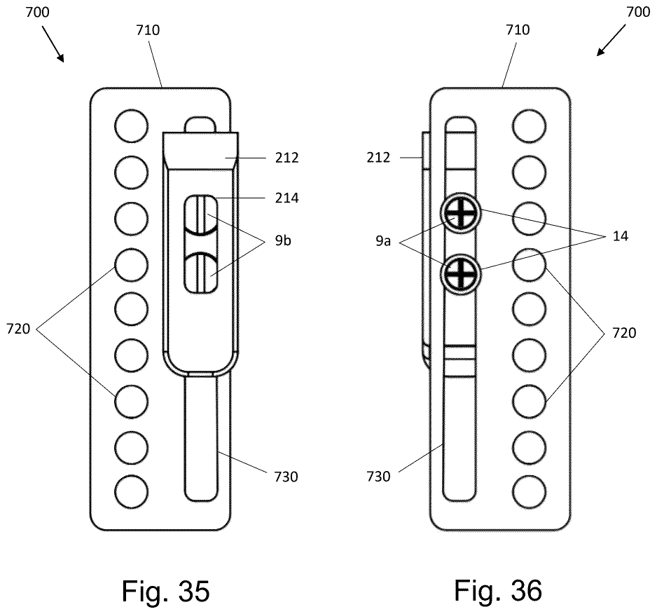

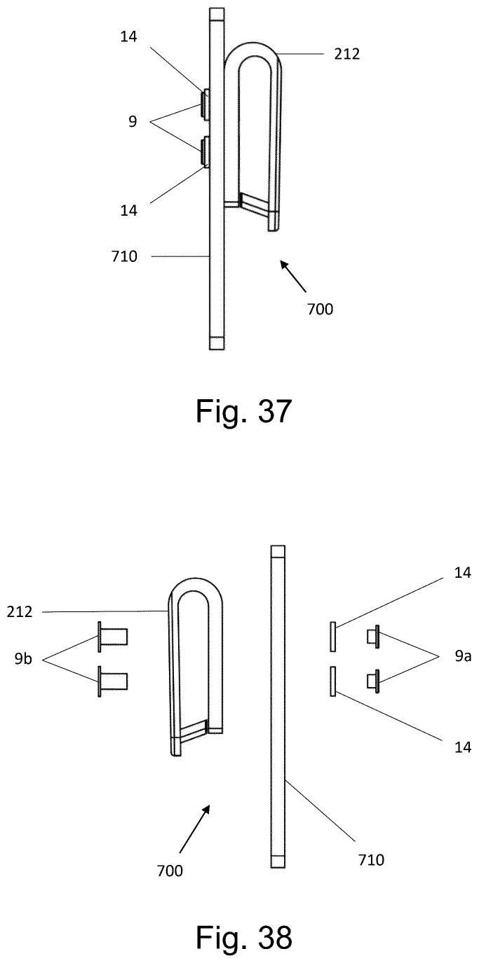

Another aspect of the present invention is directed to an adjustable clip system 700 for slidably attaching a holster or sheath to a wearer as shown in FIGS. 33-38. The adjustable clip system 700 includes a bracket plate 710 having a bracket slot 730, the bracket plate 710 attachable to the holster or sheath. The adjustable clip system 700 includes an attachment bracket 212 slidably attached to the bracket plate 710 by at least one attachment bracket fastener 9 through mount opening 216 in mounting portion 213. The adjustable clip system 700 may be attached to the holster or sheath using an at least one fastener 8, 9, 19. The bracket plate 710 includes at least one bracket plate opening 720 for extending the at least one bracket plate fastener 8, 9, 19 therethrough, for securing the bracket plate 710 to the holster or sheath. The attachment bracket 212 may be attachable to the wearer and the bracket plate 710 to allow the holster to be slidably positioned with respect to the wearer. The at least one attachment bracket fastener 9 may be a stud for retaining a spacer for slidably attaching the attachment bracket to the slot. The at least one stud may be a rivet, threaded rivet and nut, threaded fastener, or a ratcheting fastener as shown in FIGS. 21A, 21B, and 22, having a first flange on a first end integrated with a threaded cylinder and a second flange disposed on a second end opposite the first end, the second flange engageable with the threaded cylinder. The at least one bracket plate fastener 8, 9, 19 may include a first flange on a first end integrated with a threaded cylinder and a second flange disposed on a second end opposite the first end, the second flange engageable with the threaded cylinder as shown in FIGS. 21A, 21B, and 22. The adjustable clip system 700 may include a textured, compressible, interlocking, or non-slip surface on a surface of the clip or attachment bracket 212 and/or bracket plate 710. The attachment bracket 212 may include a bracket opening 214 for accessing the at least one attachment bracket fastener 9. The adjustable clip system 700 may include an at least one spacer 14. The at least one spacer 14 is adjustably engageable through adjustment to the attachment bracket fastener 9 to change the engagement of the attachment bracket 212 and/or bracket plate 710. The at least one spacer 14 may be a spring, compressible spacer, or non-compressible spacer. The bracket plate 710 and attachment bracket 214 may include a textured, compressible, interlocking, or non-slip surface on a surface of the bracket plate 710 and/or attachment bracket 214 to provide engagement.

A textured surface may be on at least one side of the channel of the adjustable clip system, adjustable position holster, channel bracket, surface mount channel bracket, adjustable torsion claw, alternative adjustable torsion claw, or alternative adjustable clip system. The surface may be used to replace the spacer such as with a textured, compressible, interlocking, or non-slip surface in order to place friction between the clip, attachable bracket, channel member, accessory channel, adjustable torsion claw upper mounting base, accessory torsion claw lower mounting base, adjustable torsion claw base, adjustable torsion claw mounting base, slotted channels, holster, and/or between the spacer and the slotted channels.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A position adjustable holster or sheath comprising:
a housing first side and a housing second side;
a compartment for placement of a tool, the compartment formed by the housing first side and the housing second side;
a channel member disposed on a first length of the housing first side, the channel member having a slot extending along a second length of the channel member;
at least one attachment bracket being slidably attached to the slot to allow the attachment bracket to slide along the second length of the slot in relation to the housing first side, the attachment bracket remaining stationary with respect to the wearer; and
at least one attachment bracket fastener extending through an opening in the attachment bracket and through the slot wherein the attachment bracket fastener secures the at least one attachment bracket slidably to the channel member.

2. The position adjustable holster or sheath of claim 1 including an accessory channel extending from a side of the position adjustable holster or sheath, the accessory channel for adjustably securing an accessory to the position adjustable holster or sheath.

3. The position adjustable holster or sheath of claim 1 including a textured, compressible, interlocking, or non-slip surface on a surface of the attachment bracket, holster, or sheath.

4. The position adjustable holster or sheath of claim 1 wherein the channel member is a raised portion of the housing first side.

5. The position adjustable holster or sheath of claim 1 wherein the at least one attachment bracket fastener is an at least one stud for retaining a spacer for slidably attaching the attachment bracket to the slot.

6. The position adjustable holster or sheath of claim 5 wherein the at least one stud is a rivet, threaded rivet and nut, threaded fastener, or a ratcheting fastener having a first flange on a first end integrated with a cylinder and a second flange disposed on a second end opposite the first end, the second flange engageable with the cylinder.

7. The position adjustable holster or sheath of claim 5 wherein the at least one spacer is a spring, compressible spacer, or non-compressible spacer.

8. The position adjustable holster or sheath of claim 5 wherein the attachment bracket includes a bracket opening for accessing the at least one attachment bracket fastener.

9. An adjustable torsion claw securable to a sheath or holster for allowing a position of the torsion claw to be adjusted in relation to the sheath or holster, the adjustable torsion claw comprising:
a torsion claw base having a torsion base slot;
a torsion claw face disposed on a surface of the torsion claw base, the torsion claw face having a textured surface;
a torsion claw mounting base for slidably mounting the torsion claw base to the sheath or holster, the torsion claw mounting base including at least one torsion claw fastener opening;
at least one torsion claw fastener extending through the torsion claw base slot for slidably fastening the torsion claw base to the torsion claw mounting base, the at least one torsion claw fastener including a first flange having a threaded cylinder protruding therefrom and a second flange engageable with the threaded cylinder, the at least one torsion claw fastener extending through the torsion base slot in the torsion claw base; and
at least one spacer disposed between the first flange of the torsion claw fastener and the torsion base slot to slidably attach the torsion claw base to the torsion claw mounting base.

10. The adjustable torsion claw according to claim 9 including a torsion claw mounting base fastener for securing the mounting base to the sheath or holster.

11. The adjustable torsion claw according to claim 9 including a textured, compressible, interlocking, or non-slip surface on a surface of the mounting base or torsion claw.

12. The adjustable torsion claw according to claim 9 wherein the at least one spacer is a spring, compressible spacer, or non-compressible spacer.

13. The adjustable torsion claw according to claim 9 wherein the at least one mounting base fastener is a stud, rivet, threaded rivet and nut, threaded fastener, or ratcheting fastener.

14. An adjustable clip system for slidably attaching a holster or sheath to a wearer, the adjustable clip system including:
a bracket plate having a slot, the bracket plate attachable to the holster or sheath;
an attachment bracket slidably attached to the bracket plate by at least one attachment bracket fastener; and
at least one bracket plate fastener for attaching the bracket plate to the holster or sheath;
wherein the bracket plate includes at least one plate opening for extending the at least one bracket plate fastener therethrough, for securing the bracket plate to the holster or sheath; and
wherein the attachment bracket is attachable to the wearer and the bracket plate allows the holster to be slidably positioned with respect to the wearer.

15. The adjustable clip system according to claim 14 wherein the at least one attachment bracket fastener is a stud for retaining a spacer for slidably attaching the attachment bracket to the slot.

16. The adjustable clip system according to claim 15 wherein the at least one stud is a rivet, threaded rivet and nut, threaded fastener, or a ratcheting fastener having a first flange on a first end integrated with a cylinder and a second flange disposed on a second end opposite the first end, the second flange engageable with the cylinder.

17. The adjustable clip system according to claim 14 wherein the at least one bracket plate fastener includes a first flange on a first end integrated with a cylinder and a second flange disposed on a second end opposite the first end, the second flange engageable with the cylinder.

18. The adjustable clip system according to claim 14 including a textured, compressible, interlocking, or non-slip surface on a surface of the attachment bracket and/or bracket plate.

19. The adjustable clip system according to claim 14 wherein the attachment bracket includes a bracket opening for accessing the at least one attachment bracket fastener.

20. The adjustable clip system according to claim 14 including an at least one spacer wherein the at least one spacer is a spring, compressible spacer, or non-compressible spacer.
